(19) United States
(12) Patent Application Publication
(10) Pub. No.: US 2001/0032195 A1
(43) Pub. Date: Oct. 18, 2001

(54) System and method for identifying productivity improvements in a business organization

(76) Inventors: Catherine Mary Graichen, Malta, NY (US); Vrinda Rajiv, Guilderland, NY (US); Pauline White, Delanson, NY (US); Martin Kalani McKenna, Arlington Height, IL (US); Kristeen Mary Schroeter, Pewaukee, WI (US); Andrew Joseph Lang, Sussex, WI (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/739,607

(22) Filed: Dec. 19, 2000

Related U.S. Application Data
(60) Provisional application No. 60/193,280, filed on Mar. 30, 2000.

(51) Int. Cl. G06F 17/60

(52) U.S. Cl. 705/400; 705/16

(57) ABSTRACT

This disclosure describes a system and method for providing efficiency and cost analysis of business operations. The system of this disclosure includes a business operations database that contains a plurality of operational data obtained from a plurality of business organizations, a processor that analyzes the plurality of operational data to identify productivity improvements in the business organization, and an analysis logic that calculates an operational efficiency of the business organization. The method provides for efficiency and cost analysis of business operations. The method includes the steps of storing a plurality of operational data obtained from a plurality of business organizations. With the plurality of operational data, the method identifies productivity improvements in the business organization and calculates an operational efficiency of the business organization.

### CROSS REFERENCE TO RELATED APPLICATIONS

This application claims the benefit of U.S. Provisional Application Ser. No. 60/193,280 filed on Mar. 30, 2000, and entitled “System and Method for Identifying Productivity Improvements in a Business Organization,” which is incorporated by reference herein in its entirety.

### BACKGROUND OF THE INVENTION

This disclosure relates to the efficiency and cost analysis of business organizations, and more specifically, describes a system and method to identify productivity improvements in a health care organization.

The medical marketplace has traditionally been a non-competitive non-threatening environment. In the last decade the environment has changed. The emergence of Preferred Provider Organizations (PPO) and capitated reimbursement have forced departments to manage costs, strive for efficiency, and cost justify investments which used to be taken for granted. This has forced the management of the departments to change their mindsets and dig for new ways to perform the same service. They want to know how they rank against other like facilities as a way to prioritize redesign efforts.

To compete in the changed healthcare marketplace, it is necessary to drive down redundant overhead and look across multiple facilities to find Best Practices. Finding Best Practices has turned out to be harder than anticipated, and the corporations are looking for ways to rack and stack their facilities to determine how improvements can be made to the overall system. In addition, solutions to cost pressure that maintain or improve the current service level are greatly valued.

Both corporations and the individual departments are looking for ways to analyze the data that they have and how to improve the operation. A system which contains pertinent information could be used to provide benchmarking through various media, analyze information to identify areas of improvement, optimize the use of available equipment and provide better health care service to the customers.

For health care centers, there is opportunity for improving the quality of their service to customers and for increasing their efficiency and cost-effectiveness. They can compare their performance, productivity, cost structure, material usage and equipment utilization with that of other like facilities and with industry benchmarks.

For companies that own numerous medical facilities, such as Columbia Health Care, there is opportunity for improvement by comparing a facility's performance to standard and world-class performance measures and to the performance of its peers within the organization. The definition of a peer may be by geographic similarities (e.g. within market, within state, within nation) and based on facility demographics (e.g. bed size, bed utilization, accreditation, specialty, etc.).

Thus, a heretofore unaddressed need exists in the industry to address the aforementioned deficiencies and inadequacies.

### BRIEF SUMMARY OF THE INVENTION

This disclosure describes a system and method for providing efficiency and cost analysis of business, e.g., health care center operations. Briefly described, in architecture, the system can be implemented as follows, as an example. The example system of this disclosure includes a business operations database that contains a plurality of operational data obtained from a plurality of business organizations, a processor that analyzes the plurality of operational data to identify productivity improvements in the business organization, and an analysis logic that calculates an operational efficiency of said business organization.

This disclosure can also be viewed as describing a method for providing efficiency and cost analysis of health care centers. In this regard, the method can be broadly summarized by the following steps: (1) storing a plurality of operational data obtained from a plurality of business organizations; (2) processing the plurality of operational data to identify productivity improvements in the business organization; and (3) calculating an operational efficiency of the business organization.

Other features and advantages of this disclosure will become apparent to one with skill in the art upon examination of the following drawings and detailed description. It is intended that all such additional features and advantages be included herein within the scope of the present invention.

### BRIEF DESCRIPTION OF THE DRAWINGS

This disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an example of the configuration of the efficiency and cost analysis system of the present invention.

FIG. 2 is a block diagram of the efficiency and cost analysis system situated within a computer readable medium, within, for example, a computer system.

FIG. 3 is a flow chart illustrating an example of the process flow of the efficiency and cost analysis system and method of the present invention.

FIG. 4 is a flow chart illustrating an example of the process flow of the input data capture process used in the system and method for efficiency and cost analysis of the present invention, as shown in FIG. 2 and FIG. 3.

FIG. 5 is a flow chart illustrating an example of the report data process used in the system and method for efficiency and cost analysis of the present invention, as shown in FIG. 2 and FIG. 3.

FIG. 6 is a flow chart of an example of the prior data capture process used in the input data capture process, as shown in FIG. 4.

FIG. 7 is a flow chart of an example of the process flow of the facility background data capture process used in the input data capture process, as shown in FIG. 4.

FIG. 8A is a flow chart illustrating an example of the process flow of the financial summary category process used in the input data capture process, as shown in FIG. 4.

FIG. 8B is a flow chart illustrating an example of the process flow of the financial summary capture process used in the system and method for efficiency and cost analysis of the present invention, as shown in FIG. 8A.

FIG. 9 is a flow chart illustrating an example of the process flow of the task time capture process used in the input data capture process, as shown in FIG. 4.

FIG. 10 is a flow chart illustrating an example of the process flow of the personnel data capture process used in the input data capture process, as shown in FIG. 4.

FIG. 11 is a flow chart illustrating an example of the process flow of the supplier information process used in the input data capture process, as shown in FIG. 4.

FIG. 12 is a flow chart illustrating an example of the process flow of the payor capture process used in the input data capture process, as shown in FIG. 4.

FIG. 13 is a flow chart illustrating an example of the process flow of the procedure definition capture process used in the input data capture process, as shown in FIG. 4.

FIG. 14 is a flow chart illustrating an example of the process flow of the image unit data capture process used in the input data capture process, as shown in FIG. 4.

FIG. 15 is a flow chart illustrating an example of the process flow of the volume and benchmark time data capture process used in the input data capture process, as shown in FIG. 4.

FIG. 16 is a flow chart illustrating an example of the process flow of the collect physician procedure preference process used in the input data capture process, as shown in FIG. 4.

FIG. 17 is a flow chart illustrating an example of the process flow of the process capture data process used in the system and method for efficiency and cost analysis of the present invention, as shown in FIG. 2 and FIG. 3.

FIG. 18 is a flow chart illustrating an example of the process flow of the demographics report process used in the report data process, as shown in FIG. 5.

FIG. 19 is a flow chart illustrating an example of the process flow of the financial report process used in the report data process, as shown in FIG. 5.

FIG. 20 is a flow chart illustrating an example of the process flow of the expense and inventory report process used in the report data process, as shown in FIG. 5.

FIG. 21 is a flow chart illustrating an example of the cycle time report process used in the report data process, as shown in FIG. 5.

FIG. 22 is a flow chart illustrating an example of the process flow of the bed utilization report process used in the report data process, as shown in FIG. 5.

FIG. 23 is a flow chart illustrating an example of the process flow of the productivity report process used in the report data process, as shown in FIG. 5.

FIG. 24 is a flow chart illustrating an example of the process flow of the savings and indicator score report process used in the report data process, as shown in FIG. 5.

FIG. 25 is a flow chart illustrating an example of the ad-hoc report process used in the report data process, as shown in FIG. 5.

### DETAILED DESCRIPTION OF THE INVENTION

Reference will now be made in detail to the description of the invention as illustrated in the drawings. Although the invention will be described in connection with these drawings, there is no intent to limit it to the embodiment or embodiments disclosed therein. On the contrary, the intent is to include all alternatives, modifications, and equivalents included within the spirit and scope of the invention as defined by the appended claims.

GE has previously developed an Asset Management Program (AMP) for analyzing procedure and technology improvements in diagnostic imaging services within a multi-hospital market. The preferred embodiment invention integrates AMP by providing a new data entry interface and permanent repository in a database, such as but not limited to, Oracle. The preferred embodiment of this invention extends AMP by allowing the analysis of procedure and imaging unit data with other data for the hospital sites including financial or questionnaire data.

A marketing group has collected data about hospitals, clinics and other medical care establishments. This data primarily focuses on demographic and financial details of the site including, patient volumes, bed utilization, case mix index, annual expenses and revenues. This invention utilizes the data collected and extends that functionality by providing the ability to enter more detailed information about the site at the facility level and at the department and modality levels. The efficiency and cost analysis system provides mechanisms to report the information from a single site or to compare multiple sites.

This invention provides cross-industry, cross-facility, and intra-department analysis and reporting. It allows a consultant to perform the following acts: easily analyze data taken over an extended time period, compare facilities within a corporate affiliation to find best practices and identify internal opportunities, and compare facilities versus other like facilities to identify industry best practices and areas of opportunity.

In addition, it reduces the amount of time required to complete a consultant engagement and increases quality by electronically gathering normalized (i.e. standardized, succinct) data.

The efficiency and cost analysis system for identifying productivity improvements provides the consultants with a system and method to quantify the current state of a facility, to look for savings opportunities and opportunities to enhance the clients operation, and to provide a business case for potential projects. The business case includes investment options, return on investment (ROI), savings opportunities, organizational changes, technological changes, or process changes. Organization changes may include shifting Full Time Equivalent (FTE) hours to different areas of focus or restructuring the department to eliminate unnecessary management layers. Technological changes may include upgrading a materials management system or adding more network equipment to enhance the data exchange between sites. Process changes may include changing the materials ordered by a department or changing the way a patient checks into a department for an exam. To identify such opportunities, the consultants collect data, store it in database, generate site and comparison reports and perform ad-hoc analysis to determine primary areas of focus and solutions to operational challenges.

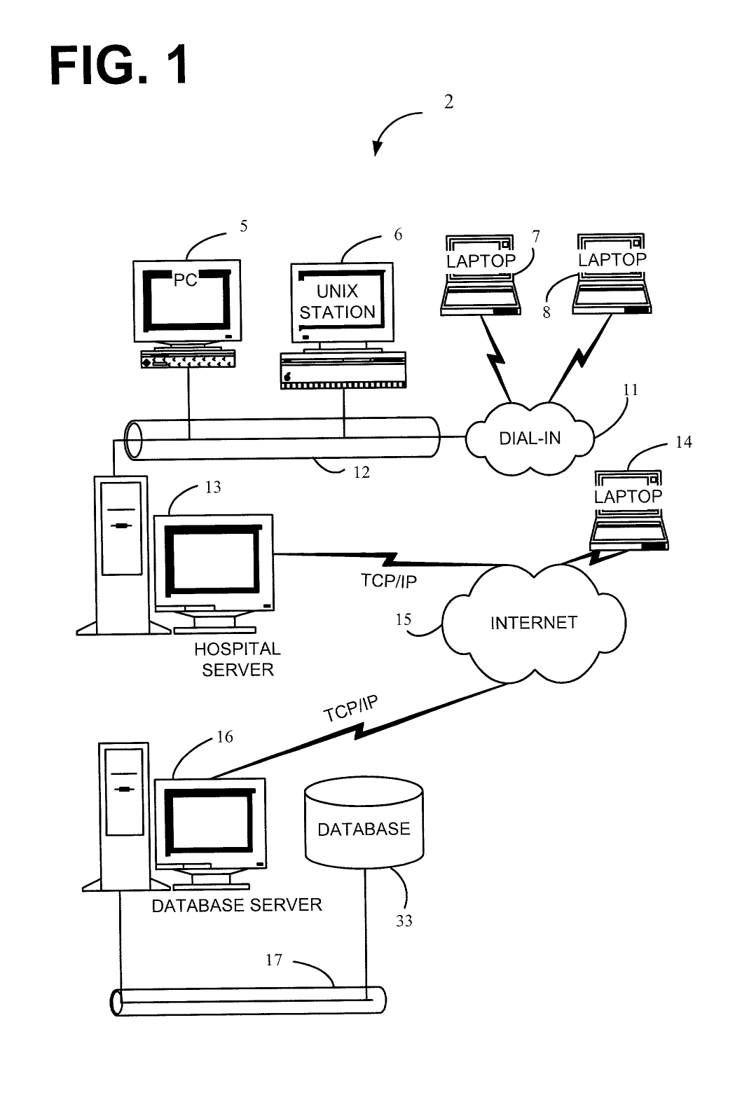

Turning now to the drawings, FIG. 1 is a block diagram of possible system configuration 2 that illustrates the flexibility and platform independence of the efficiency and cost analysis system and method of the present invention. While the configuration of the efficiency and cost analysis system could take many forms, the diagram of FIG. 1 illustrates a plurality of computer systems 5, 6, 13, or 16 that may be connected to a health care consultant's data input device 7, 8, or 14 (i.e. PC, workstation, laptop, or other device) either directly or through a network. A network can be for example, but is not limited to, a dial-in, coaxial cable, Ethernet, LAN, WAN, PSTN, Intranet and/or Internet networks 11, 12, 15 and 17. Each of the computer systems in FIG. 1 are uniquely illustrated to emphasize that efficiency and cost analysis system may operate on diverse hardware platforms. In configurations where the a health care consultant's data input device is not connected to a computer system, the consultant measures and inspects the data and physically records the results, which then are entered into the system manually or through data input files.

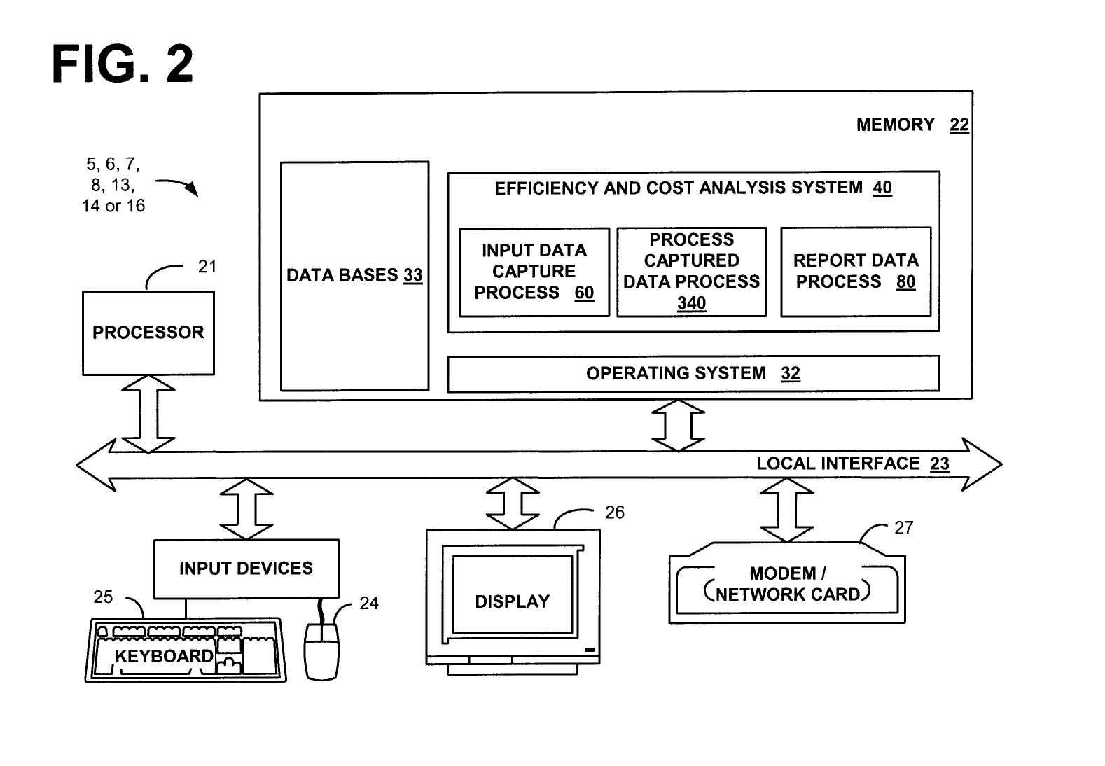

As illustrated in FIG. 2, the efficiency and cost analysis system 40 is shown residing in computer systems 5-8, 13, 14 or 16. These computer systems 5-8, 13, 14 or 16 generally comprises a processor 21 and memory 22 (e.g., RAM, ROM, hard disk, CD-ROM, etc.) with an operating system 32. Databases 33 are also shown to reside in memory area 22. The processor 21 accepts code and data from the memory 22 over the local interface 23, for example, a bus(es). Direction from the user can be signaled by using input devices, for example but not limited to, a mouse 24 and a keyboard 25. The actions input and resulting output are displayed on the display terminal 26 or printer (not shown). An efficiency and cost analysis system 40 can access other computers and resources on a network utilizing modem or network card 27.

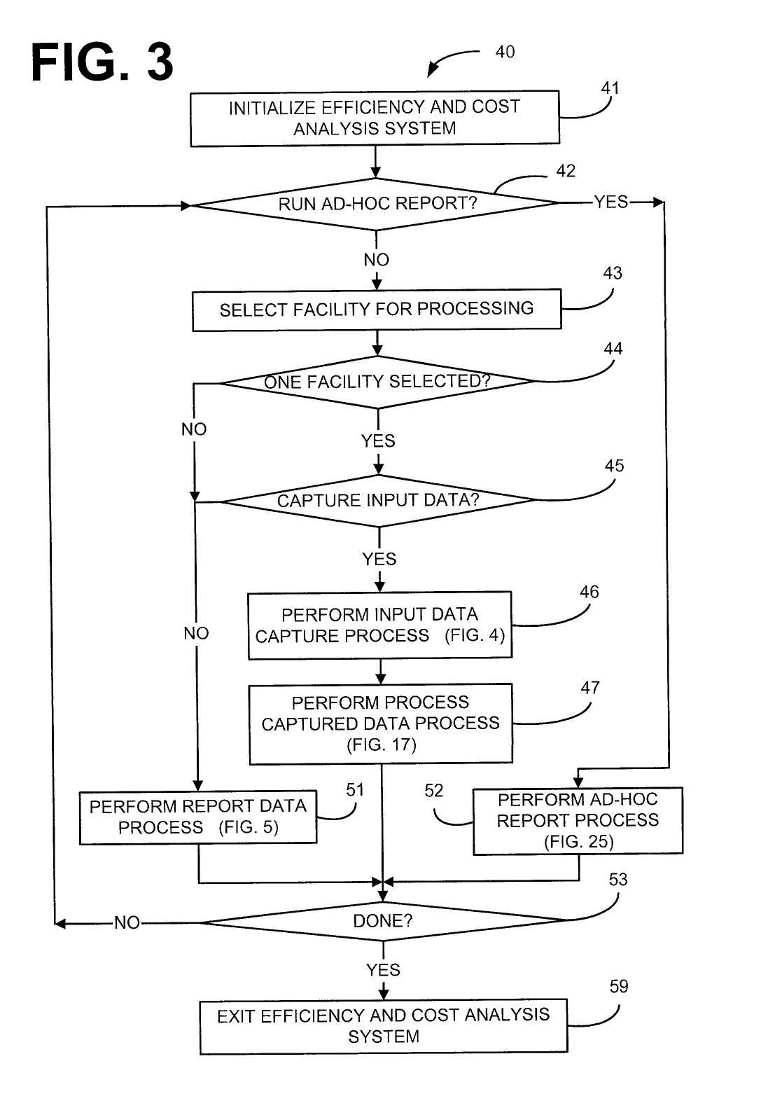

Also shown in FIG. 2 are the processes that comprise the efficiency and cost analysis system 40. The efficiency and cost analysis system 40 includes the following processes: input data capture 60, process captured data process 340, and report data process 80 in memory area 22. These components are herein described in further detail with regard to FIGS. 3-25.

The memory area 22 can be, for example but not limited to, an electronic, magnetic, optical, electromagnetic, infrared, or semiconductor system, apparatus, device, or propagation medium. More specific examples (a non-exhaustive list) of the memory area 22 include any one or more of the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

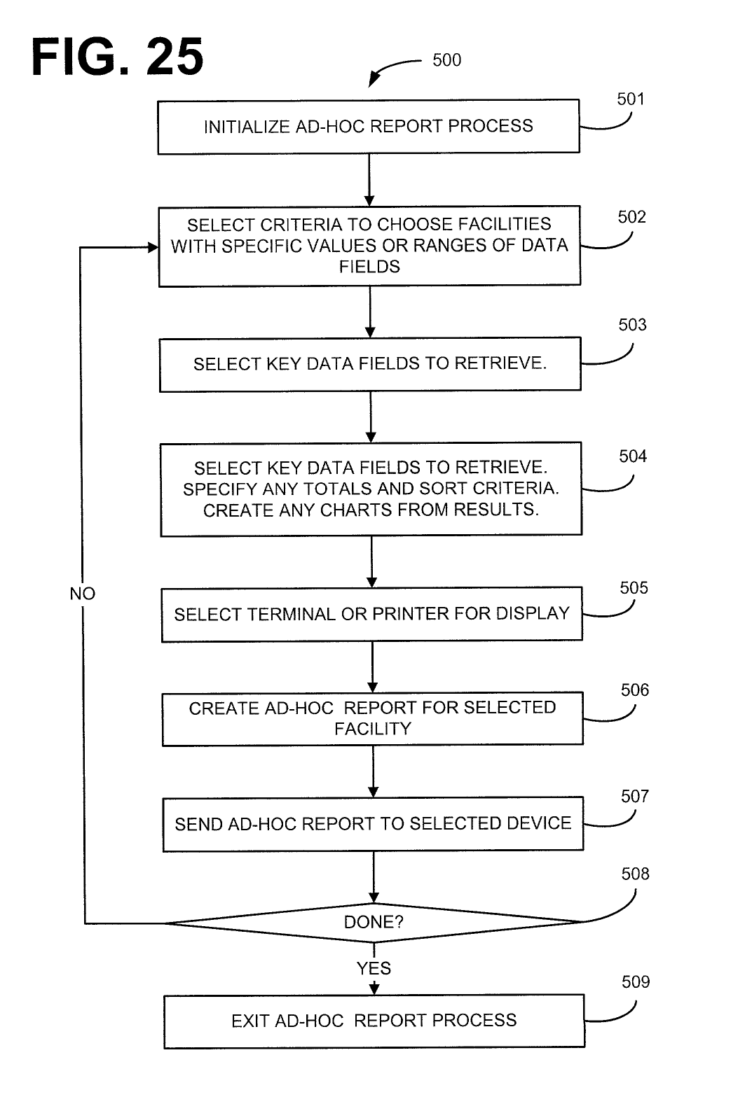

Illustrated in FIG. 3 is a flow chart of an example of the efficiency and cost analysis system 40 of this disclosure. First, a user initializes the efficiency and cost analysis system 40 at step 41. Next, it is determined whether the user wants to run ad-hoc reports at step 42. If it is determined at step 42 that ad-hoc reports are to be run the efficiency and cost analysis system 40 then skips to step 52 to enable a user to construct and run ad-hoc reports using the ad-hoc report process. The ad-hoc report process enables a user to obtain any selected type key data to be retrieved and computed and output in a user-defined report. The ad-hoc report process is herein defined in further detail with regard to FIG. 25. After performing the run ad-hoc reports process at step 52, the efficiency and cost analysis system then proceeds to step 53.

If it is determined at step 42 that the ad-hoc reports process is not to be run, the efficiency and cost analysis system 40 then prompts the user to select one or more facilities for processing at step 43. The system provides several filter criteria to list the facilities available for selection, including, but not limited to, facilities within one enterprise organization, facilities within a user-defined region or market, facilities within a specific state or province. At step 44, it is determined whether one facility was selected.

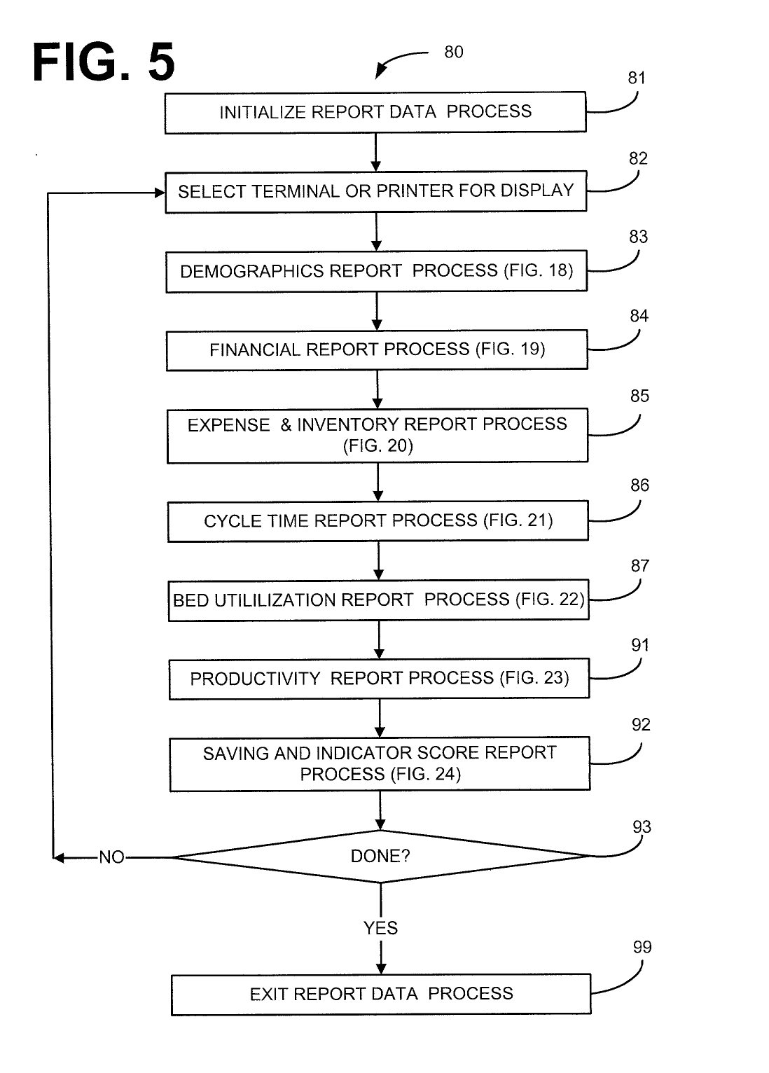

If it is determined at step 44 that more than one facility was selected, the efficiency and cost analysis system 40 then performs the report data process at step 51. The perform report data process is herein defined in further detail with regard to FIG. 5. After performing the report data process at step 51, the efficiency and cost analysis system then proceeds to step 53.

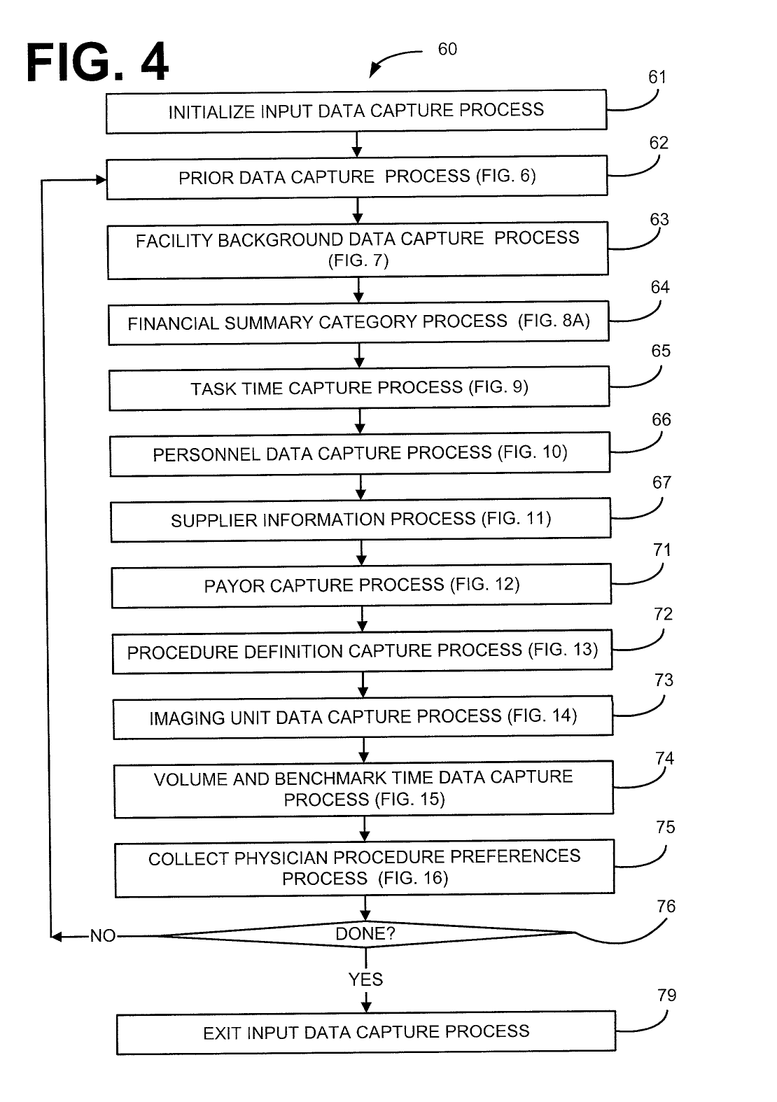

If it is determined at step 44 that only one facility was selected, the efficiency and cost analysis system 40 then determines at step 45 whether it is to capture input data. If it is determined at step 45 that the efficiency and cost analysis system 40 is to capture data, the efficiency and cost analysis system 40 then performs the input data capture process at step 46. The input data capture process is herein defined in further detail with regard to FIG. 4.

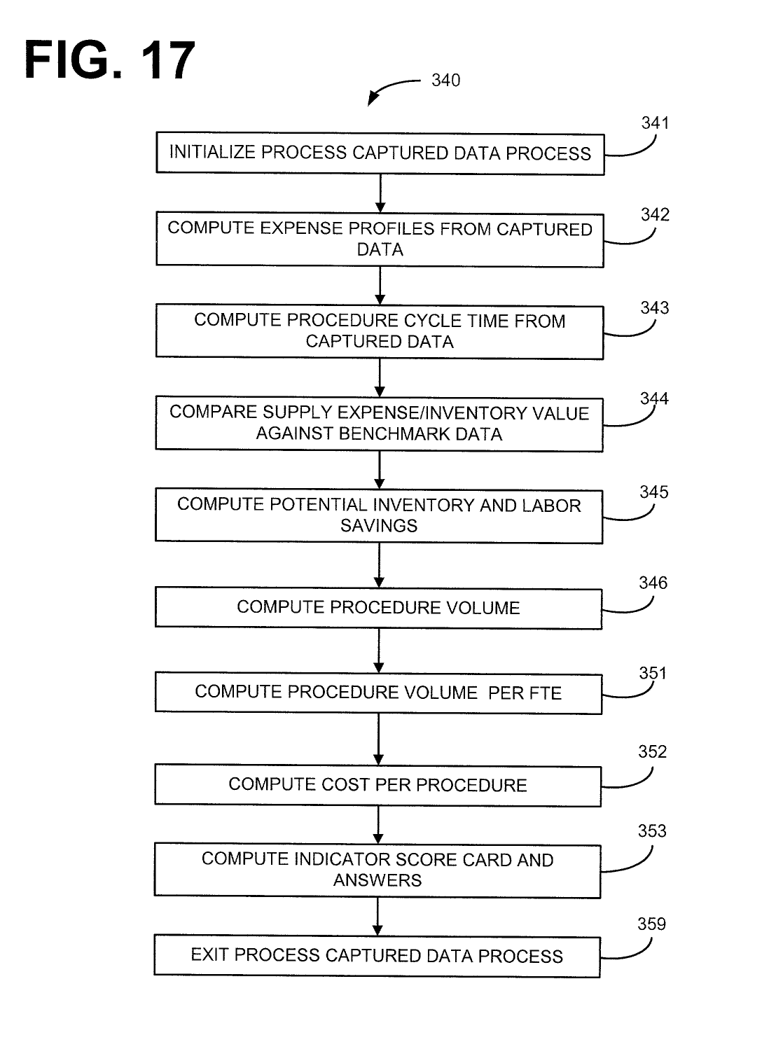

After performing the input data capture process at step 46, the efficiency and cost analysis system 40 then performs the process capture data process at step 47. The process capture data process is herein defined in further detail with regard to FIG. 17. After completion of the processing of the captured data, the efficiency and cost analysis system 40 then skips to step 53.

However, if it was determined at step 45 that the efficiency and cost analysis system is not to capture data, the efficiency and cost analysis system then performs a report data process at step 51 and proceeds as defined above. The report data process is herein defined in further detail with regard to FIG. 5.

At step 53, the efficiency and cost analysis system 40 then determines whether it is done processing facilities. If it is determined at step 53 that the efficiency and cost analysis system 40 is not done processing facilities, the efficiency and cost analysis system 40 then returns to repeat steps 42 through 53. However, if it is determined at step 53 that the facility processing is done, the efficiency and cost analysis system 40 then exits at step 59.

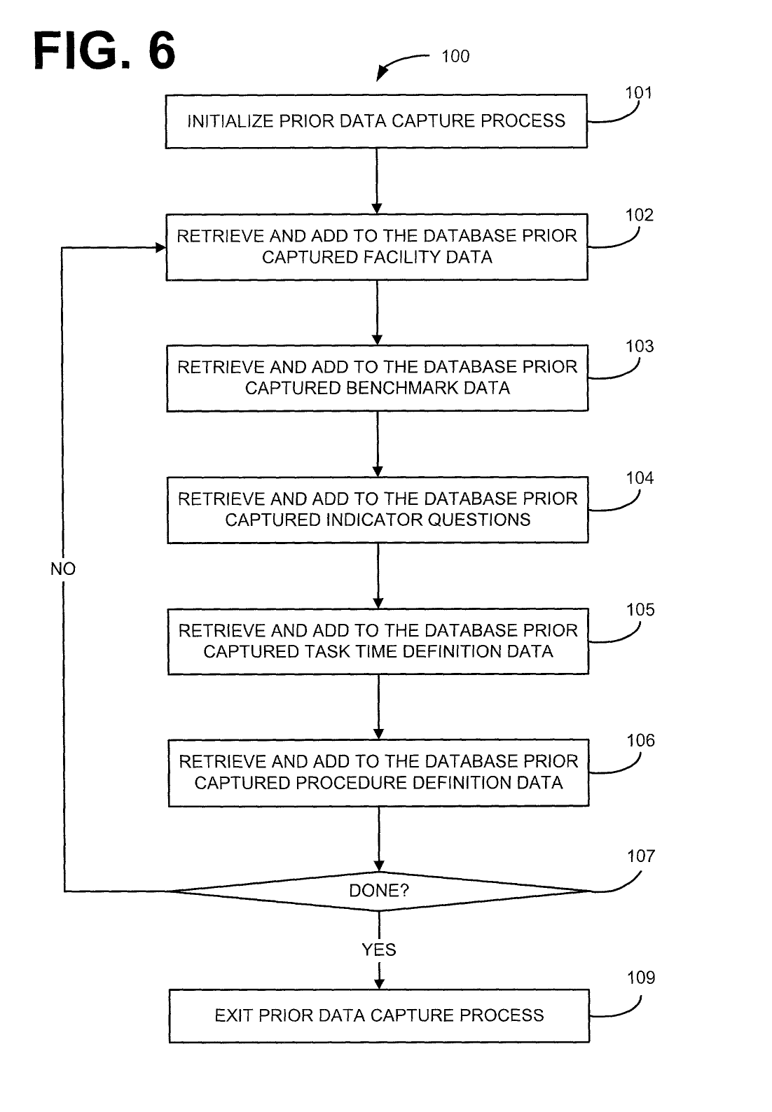

Illustrated in FIG. 4 is a flow chart of an example of the input data capture process 60 that can be utilized in the efficiency and cost analysis system 40 of this disclosure. First, the input data capture process 60 is initialized at step 61. Next, the input data capture process 60 then performs prior data capture process at step 62. The prior data capture process allows previously captured data to be input into the efficiency and cost analysis system of this disclosure. The input data capture process is herein defined in further detail with regard to FIG. 6.

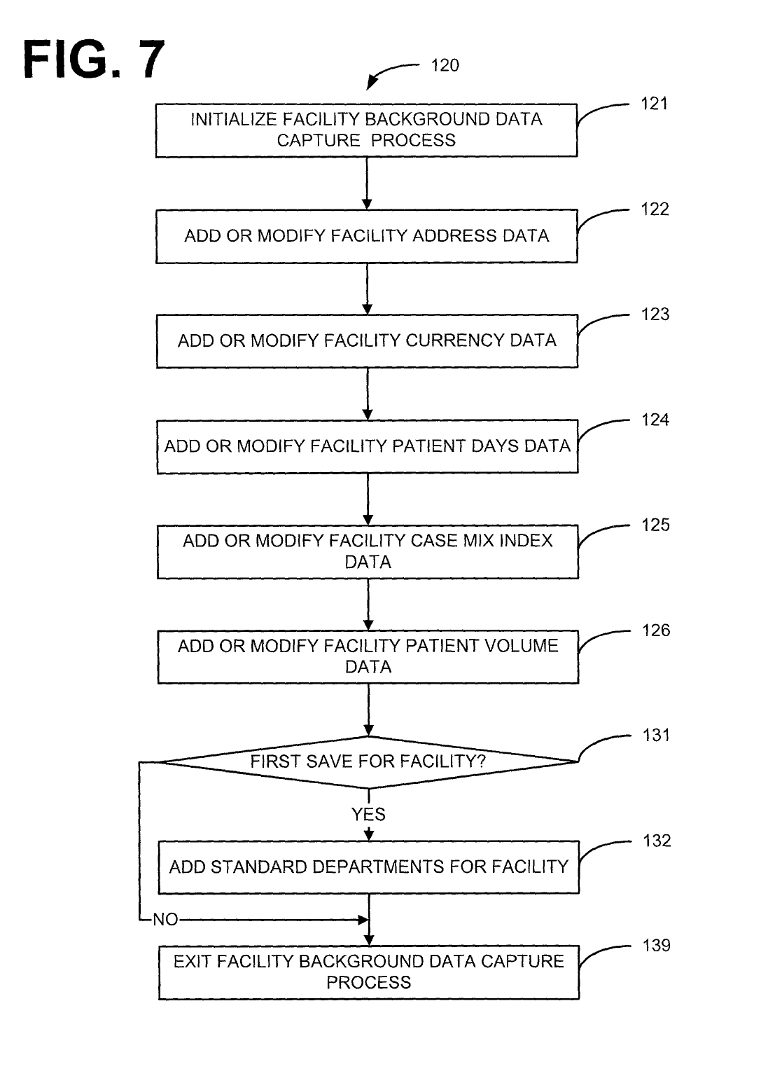

Next, the input data capture process 60 performs the facility background data capture process at step 63. The facility background data capture process enables the user to capture facility background data. The facility background data capture process is herein defined in further detail with regard to FIG. 7.

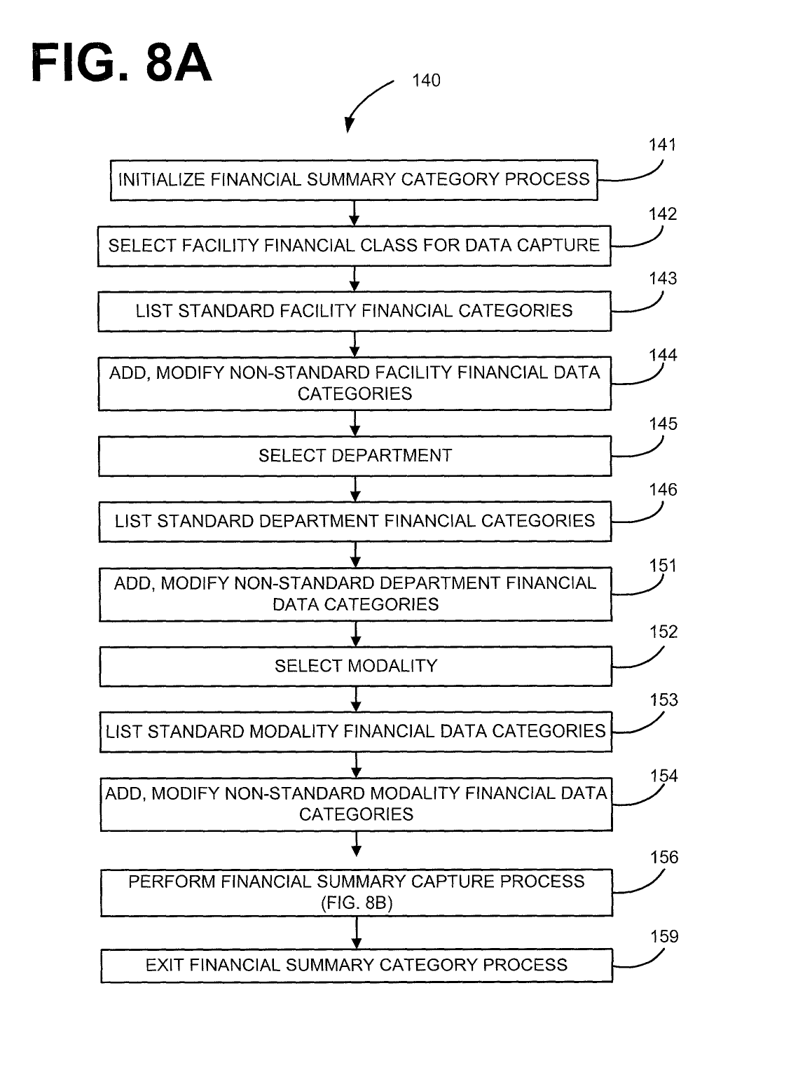

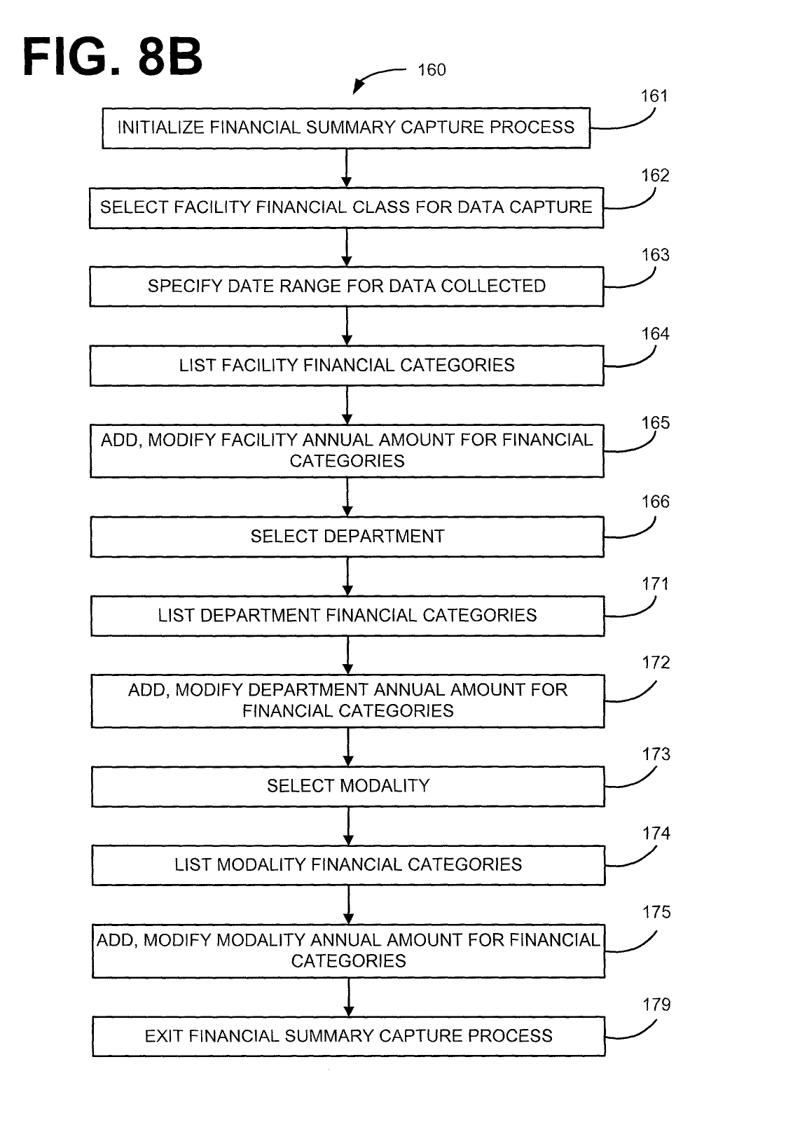

The input data capture process 60 then performs the financial summary category process at step 64. The financial summary category process enables a user to categorize and capture financial summary data. The financial summary category process is herein defined in further detail in regard to FIG. 8A.

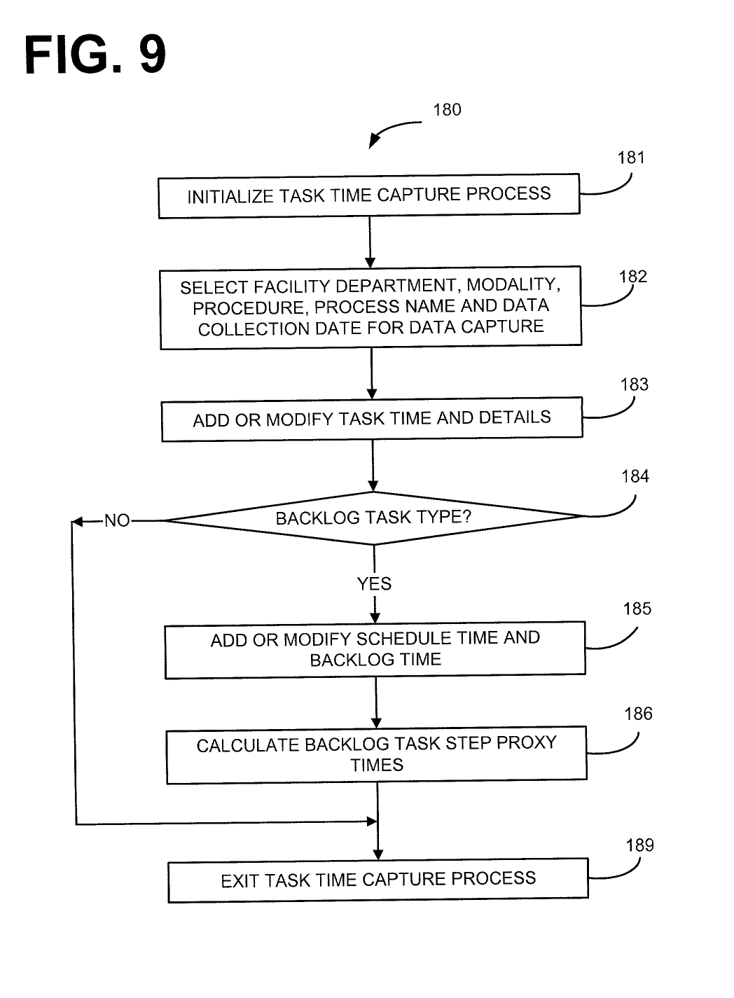

The task time capture process is next performed at step 65. The task time capture process enables a user to acquire or modify task time and details for selected facility departments modality procedures process names. The task time capture process also allows the user to add or modify scheduled and backlog time. The task time capture process is herein defined in further detail with regard to FIG. 9.

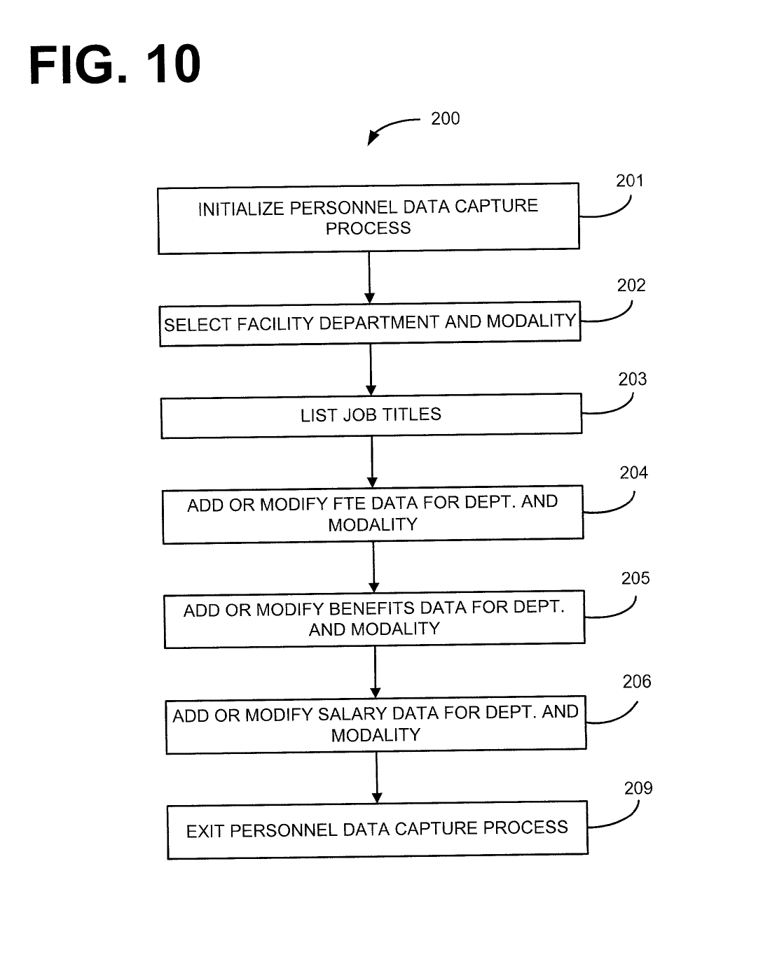

Next, at step 66, the input data capture process 60 performs the personnel data capture process. The personnel data capture process enables a user consultant to capture full time employment for department and modality as well as benefit and salary data. The personnel data capture process is herein defined in further detail with regard to FIG. 10.

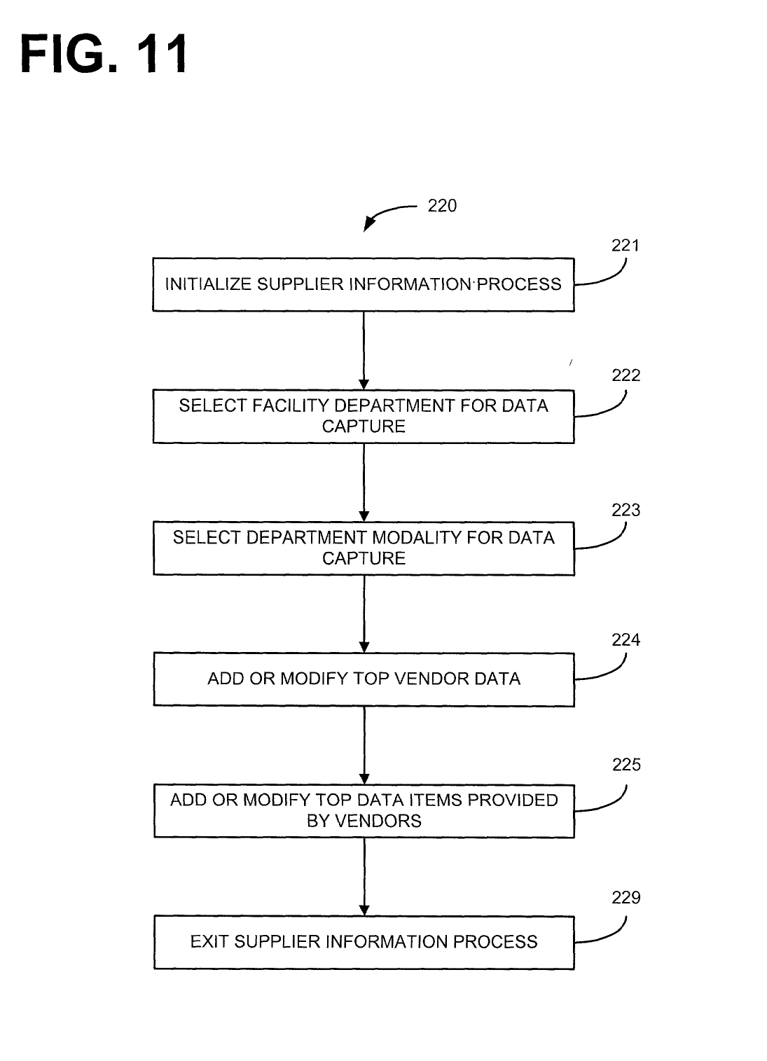

The input data capture process 60 performs the supplier information process at step 67. The supplier information process enables a user to input and modify top vendor and top item data provided by each vendor. The supplier information process is herein defined in further detail with regard to FIG. 11.

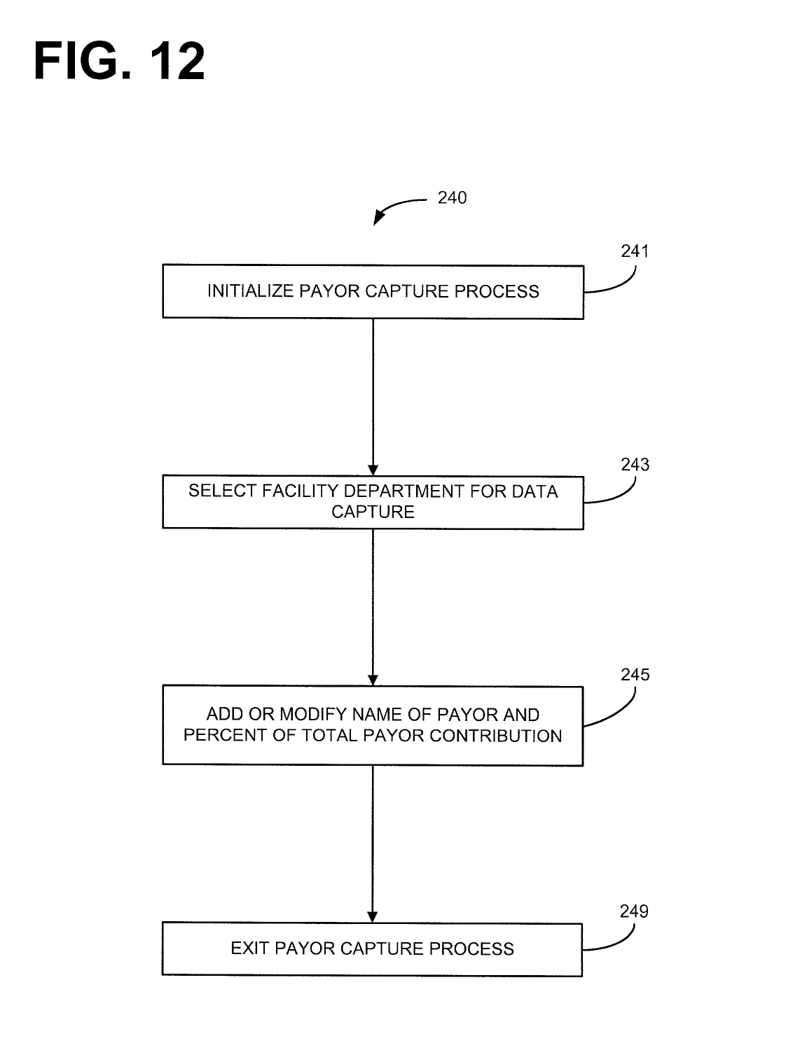

At step 71, the payor capture process is performed. The payor capture process enables the consultant or user to add or modify the names of procedures and services and the percentage of total payor contribution. The payor, in most cases, is an insurance company, or the like. The payor capture process is herein defined in further detail with regard to FIG. 12.

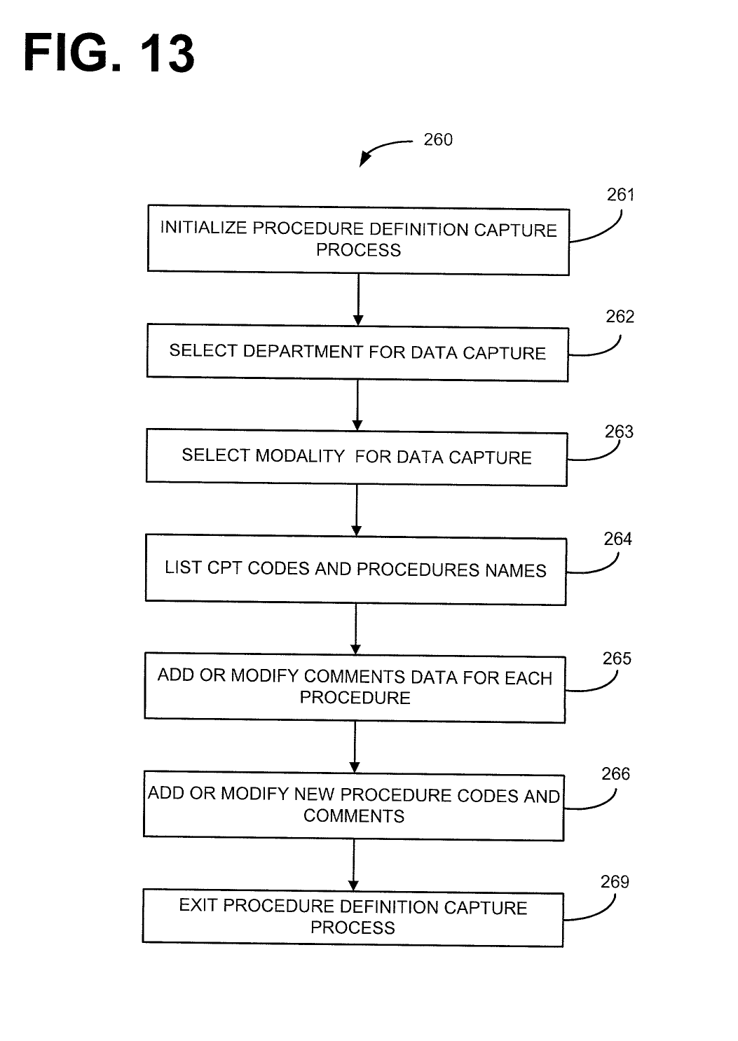

Next, the input data capture process 60 performs the procedure definition capture process at step 72. The procedure definition capture process enables a user consultant to add or modify procedures and CPT codes (Current Protocol Terminology from the American Medical Association) for each procedure. The procedure definition capture process is herein defined in further detail with regard to FIG. 13.

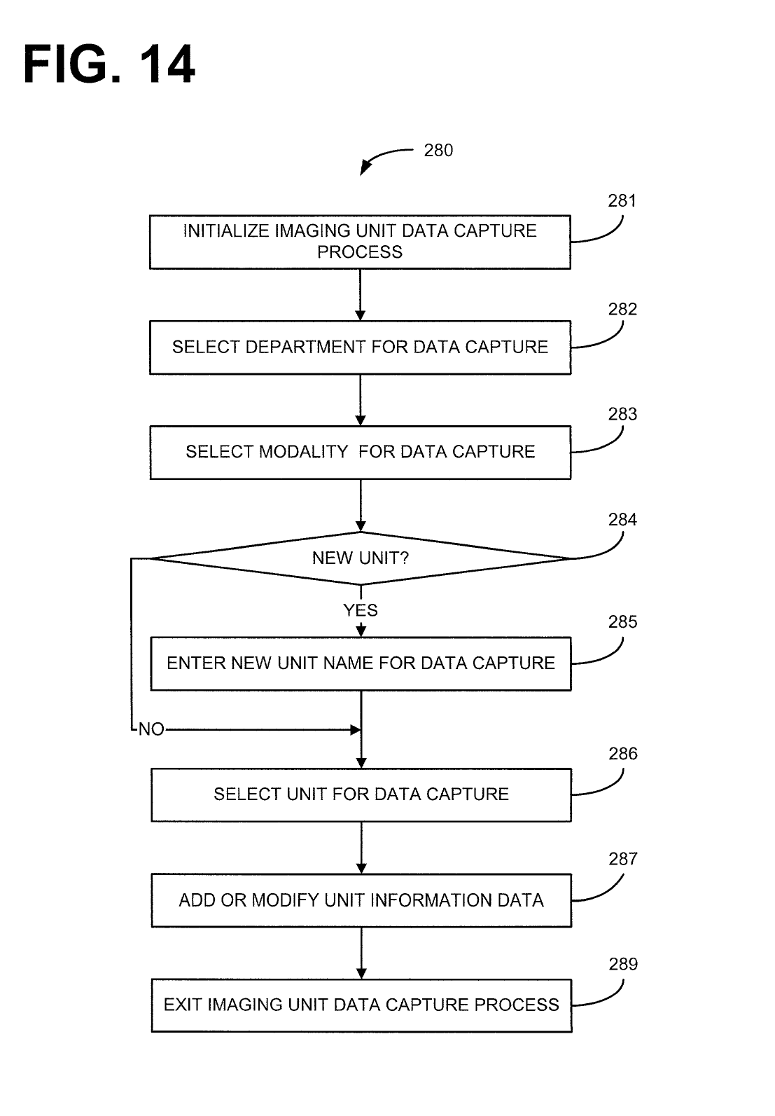

At step 73, the input data capture process 60 performs the image unit data capture process. The image unit data capture process enables a user to add or modify data for a unit by modality, department and facility. The image unit data capture process is herein defined in further detail with regard to FIG. 14.

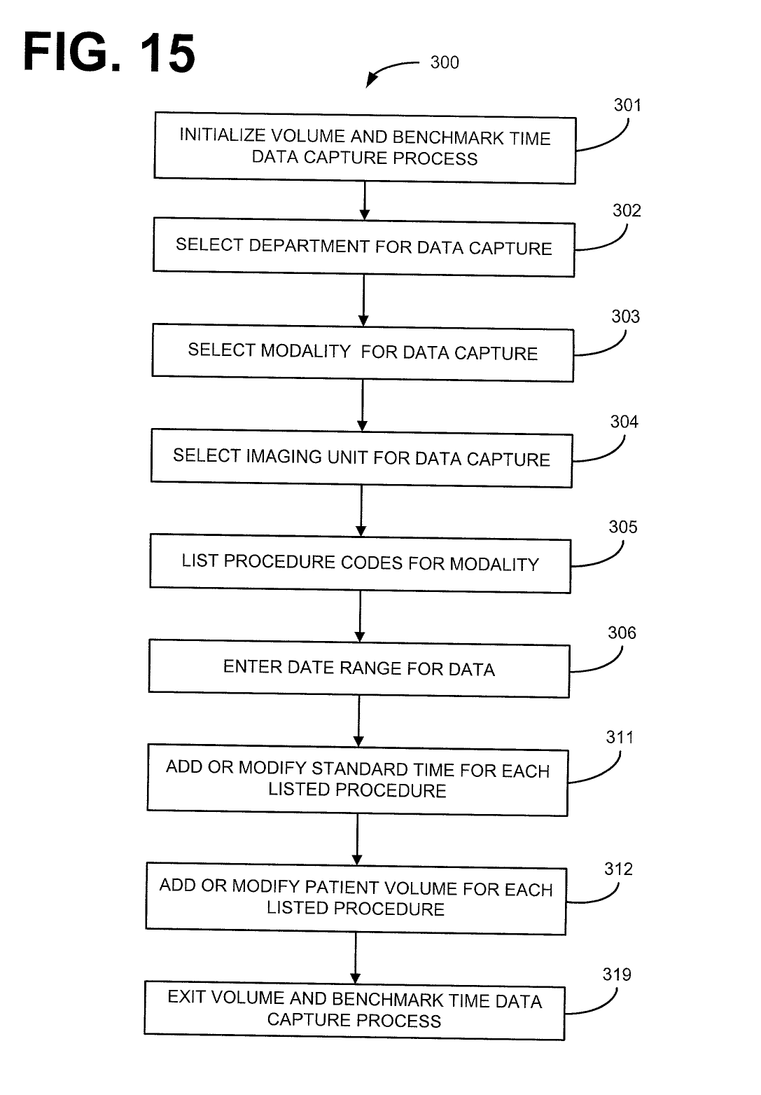

Next, the input data capture process 60 performs the volume and benchmark time data capture process at step 74. The volume and benchmark time data capture process enables a user to identify or modify the standard time allowable for each procedure and the patient volume for each procedure by modality, department and facility. The volume and benchmark time data capture process is herein defined in further detail with regard to FIG. 15.

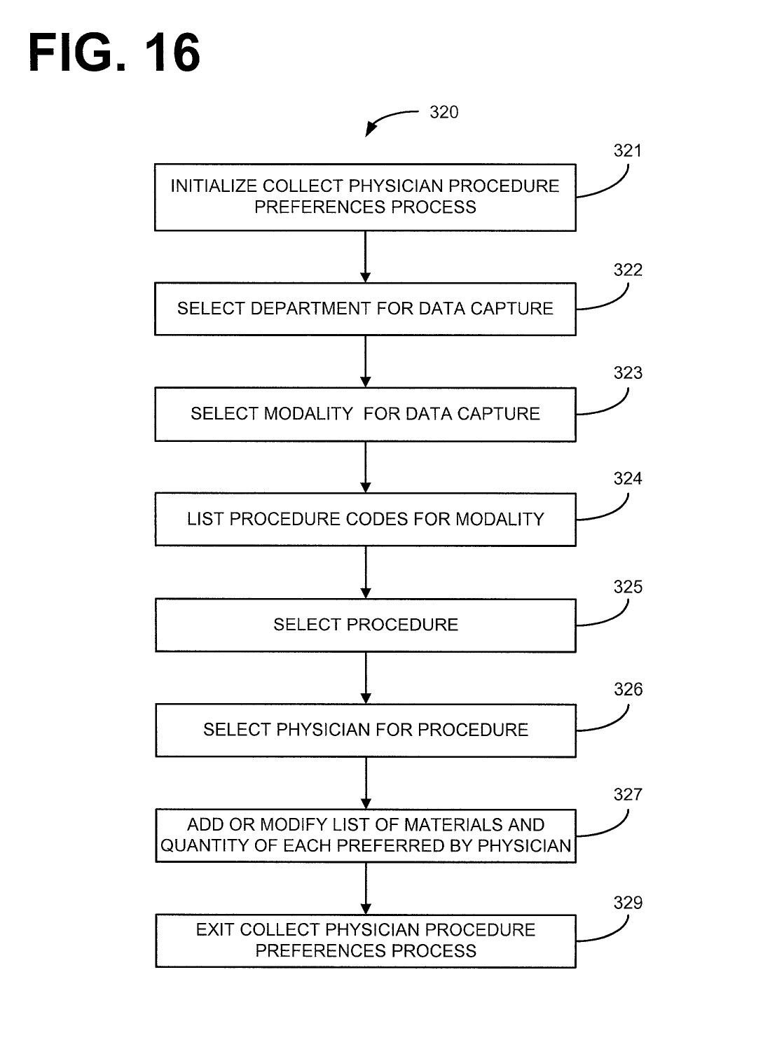

Lastly the input data capture process 60 performs the collect physician procedure preferences process at step 75. The collect physician procedure preferences process enables a user consultant to add or modify the physicians to perform each procedure for each facility, department and modality. The collect physician procedure preference process is herein defined in further detail with regard to FIG. 16.

The input data capture process 60 then determines whether the input of data is completed at step 76. If there is more data to be captured, the input data capture process 60 returns to repeat steps 62 through 76. If it is determined at step 76 that the input data capture is complete, the input data capture process then exits at step 79.

Illustrated in FIG. 5 is the report data process 80. The report data process 80 provides a consultant or user with the capability to generate a wide variety of input and computed data and to report that in a manner that the consultant or user can utilize for analysis to improve the efficiency and cost effectiveness of the facility to be analyzed. First, the report data process 80 is initialized at step 81.

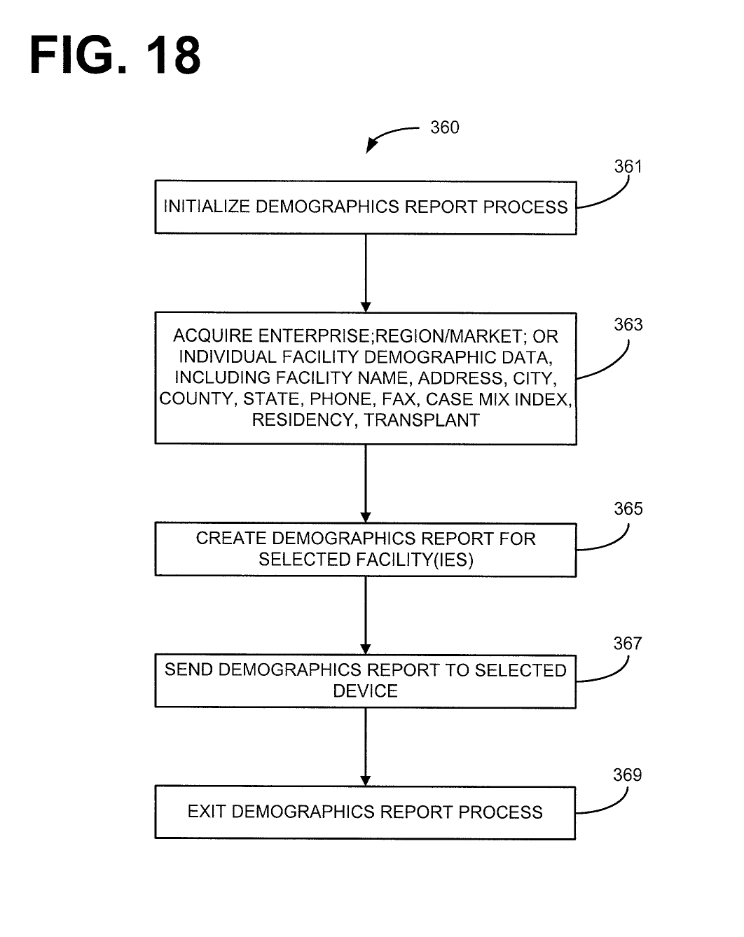

At step 82, the report data process 80 prompts the user to select a terminal or printer for the report display. At step 83, the demographics report process is executed. The demographics report process provides demographic data for selected facilities by enterprise, region/market, or individual facility. The demographics report process is herein defined in further detail with regard to FIG. 18.

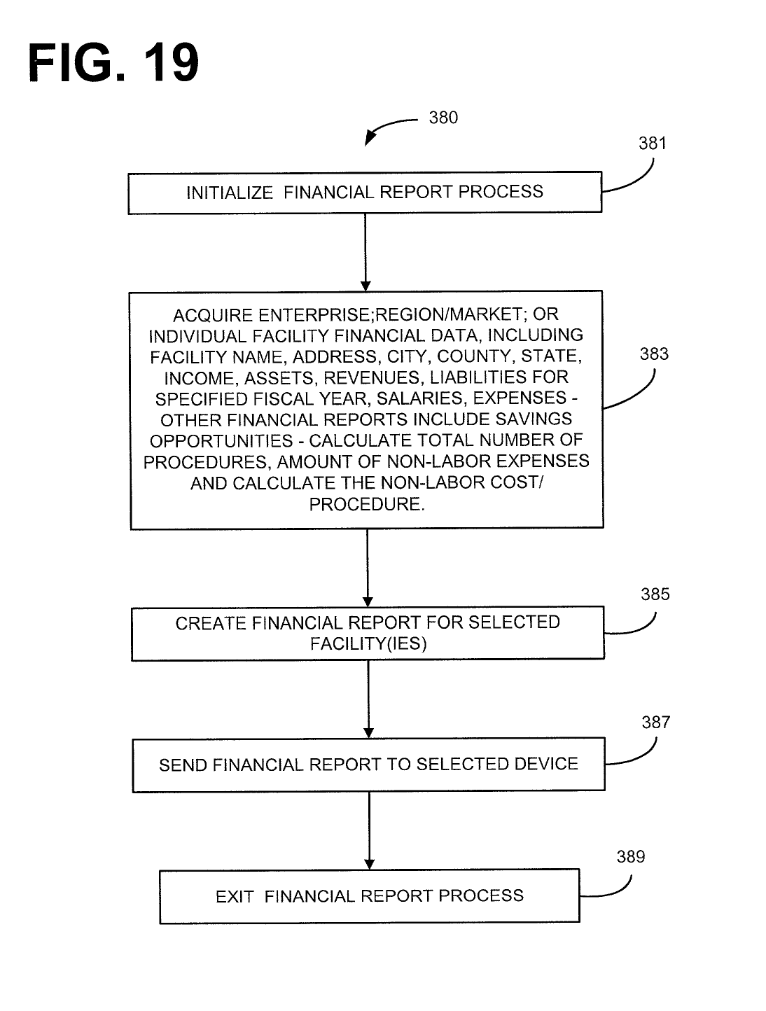

Next, at step 84, the report data process executes the financial report process. The financial report process enables a user/consultant to receive facility financial data by enterprise, region/market or individual facility. The financial report process is herein defined in further detail with regard to FIG. 19.

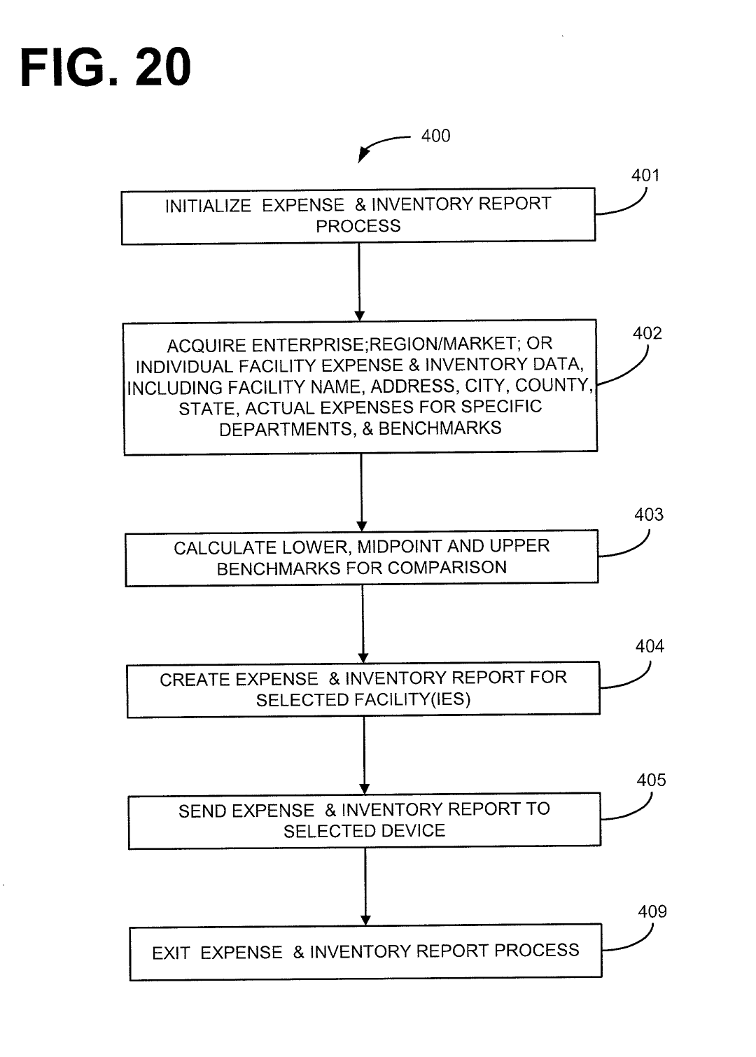

At step 85, the report data process 80 executes the expense and inventory report process. The expense and inventory report process enables a user to prepare reports regarding facility expense and inventory data for facilities within an enterprise, region or market, or an individual facility. The expense and inventory report process is herein defined in further detail with regard to FIG. 20.

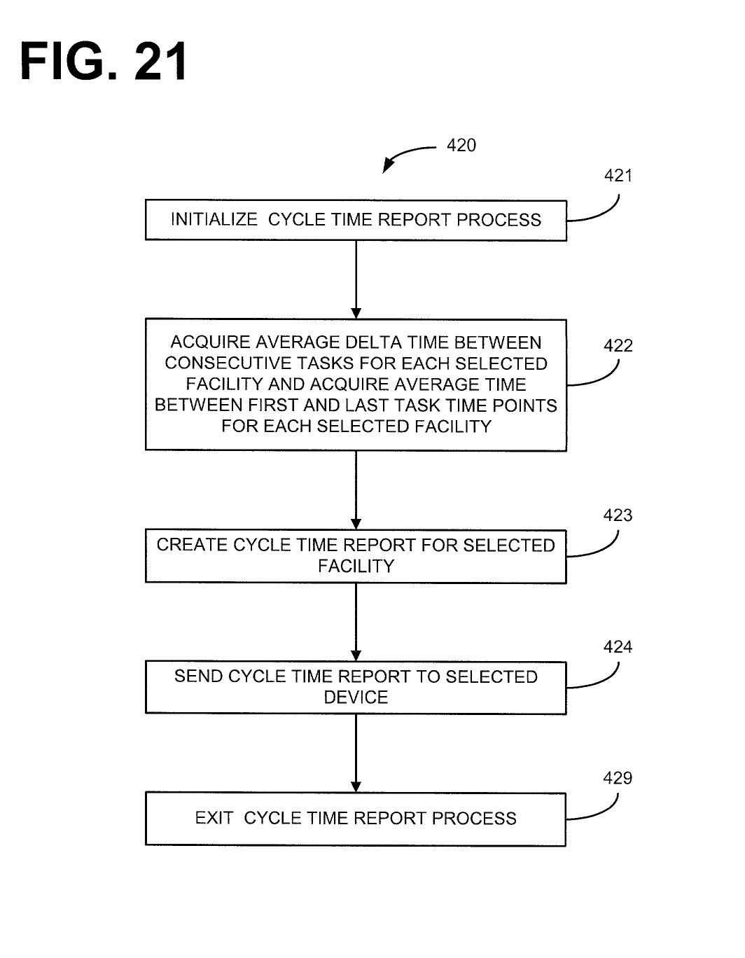

Next, the report data process 80 executes the cycle time report process at step 86. The cycle time report process enables a user to obtain the average delta time between consecutive task for selected facilities, departments, modalities and procedures. In this way, the user can determine the effectiveness of a particular department and modality for specific procedures. The cycle time report process is herein defined in further detail with regard to FIG. 21.

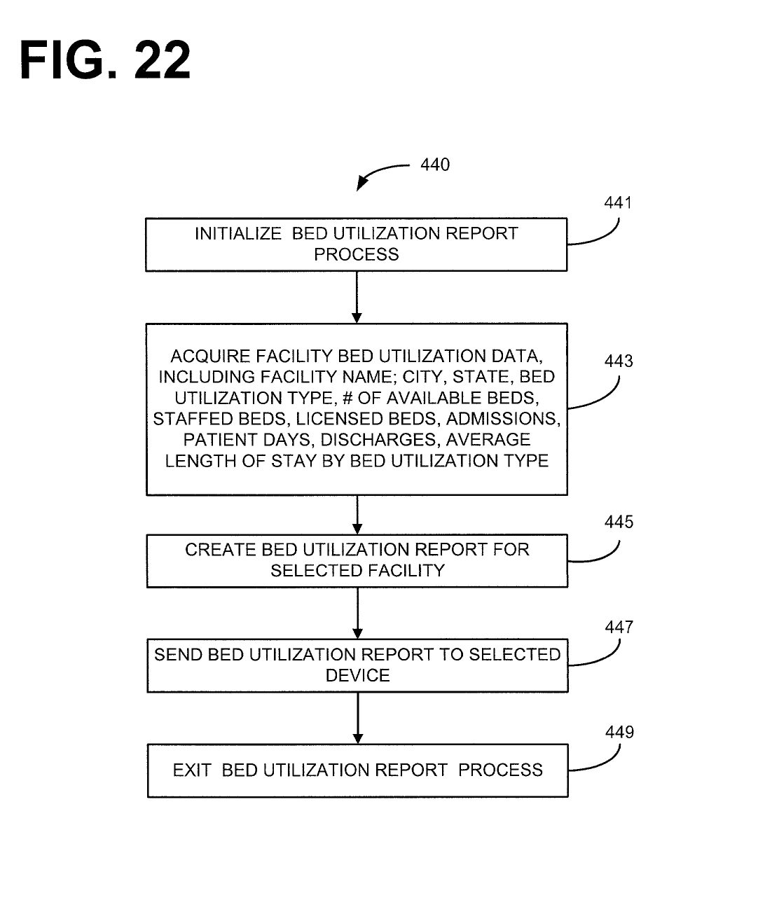

At step 87, the report data process 80 executes the bed utilization report process. The bed utilization report process provides the user consultant with the ability to obtain bed utilization data by facilities in an enterprise or particular region and market or by an individual facility. The bed utilization report process is herein defined in further detail with regard to FIG. 22.

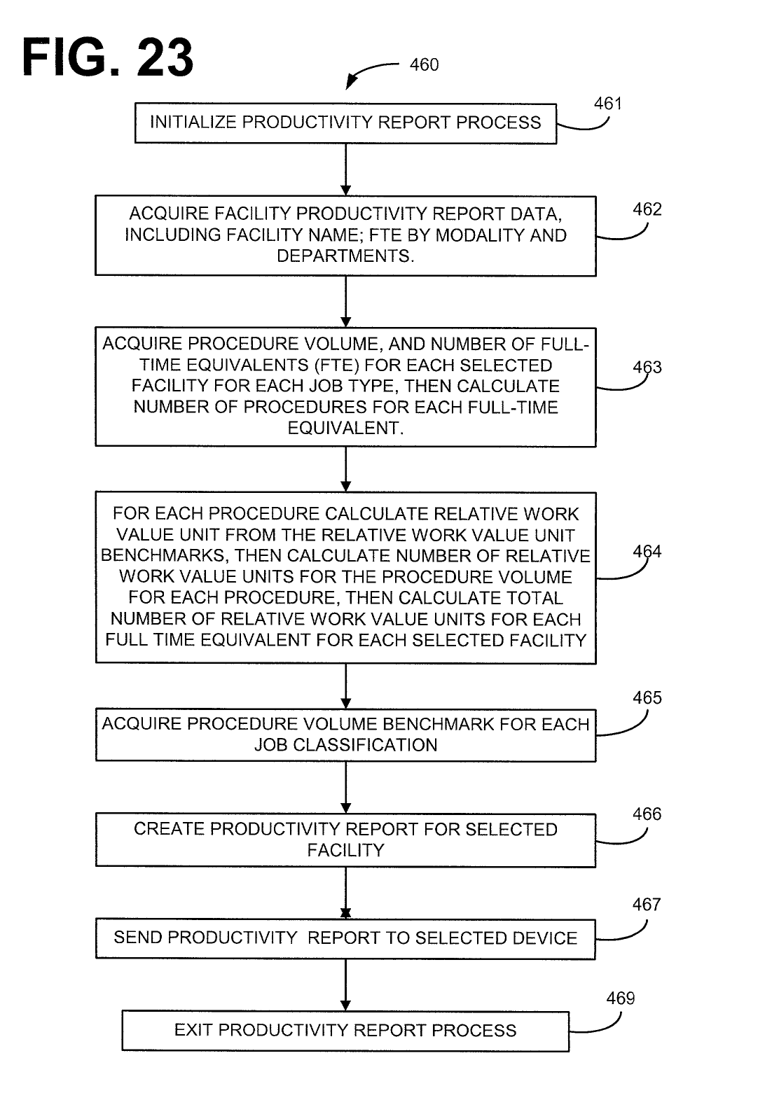

Next, the report data process 80 executes the productivity report process at step 91. The productivity report process enables a user to obtain output data with regard to procedure volume and personnel requirements for selected facilities and then computes the actual productivity effectiveness by calculating the number of procedures for each full time employee. The productivity report process is herein defined in further detail with regard to FIG. 23.

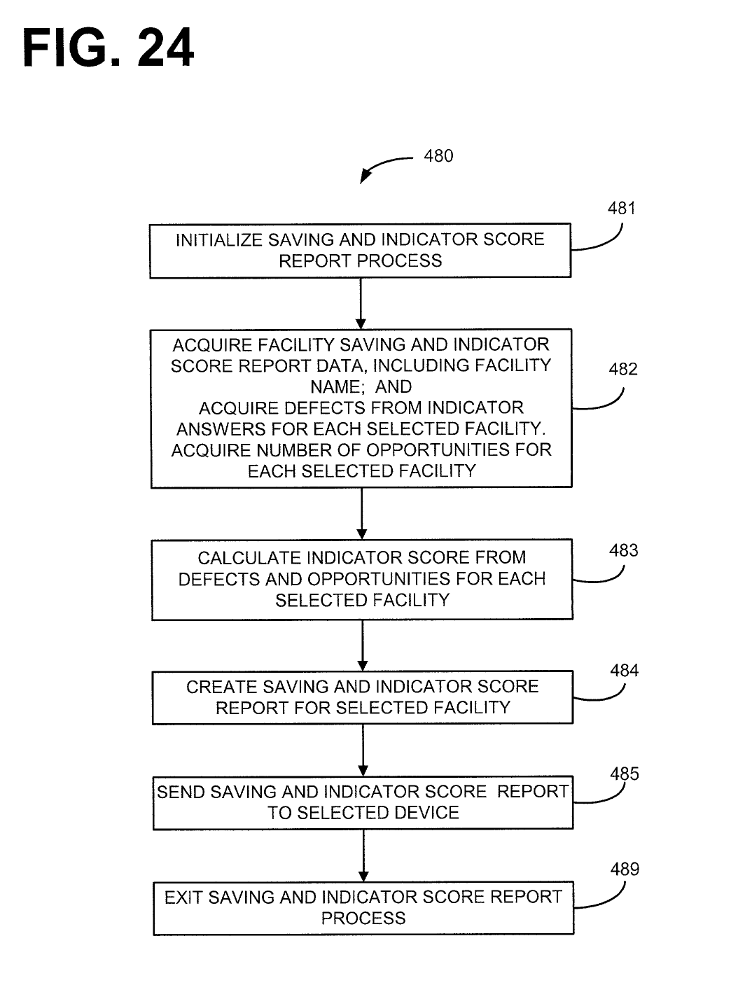

At step 92, the report data process 80 then performs the savings and indicator score report process. The savings and indicator score report process enables a user to acquire facility savings and indicator data for selected facilities. The indicator data identifies those areas in which savings could be obtained for a particular facility and opportunities to implement cost saving methodologies. The savings and indicator score report process is herein defined in further detail with regard to FIG. 24.

At step 93, the report data process 80 then determines whether or not it is done processing reports for facilities. If it determined that there are more facility reports to be processed, the report data process 80 then returns to repeat steps 82 through 93. If it is determined at step 93 that there are not more facility reports to be processed, the report data process 80 exits at step 99.

Illustrated in FIG. 6 is the prior data capture process 100 that can be utilized by the efficiency analysis system 40 described in this disclosure. The prior data capture process 100 allows previously captured data to be input into the efficiency and cost analysis system of this disclosure. The prior data capture process is initialized at step 101.

At step 102, the prior data capture process 100 enables a user to retrieve and add to the database prior captured facility data. Next, at step 103, the prior data capture process enables a user consultant to retrieve and add to the database prior captured benchmark data. At step 104, the user and consultant is enabled to retrieve and add to the database any prior captured indicator questions. The prior captured task time and definition data is enabled for retrieval and addition to the database at step 105.

Next, at step 106, the user is enabled to retrieve and add to the database any prior captured procedural definition data. At step 107, the prior data captured process 100 determines whether it is done retrieving and adding to the database prior captured data. If it is determined at step 107 that there is more prior captured data to be retrieved and added to the database, the prior data captured process 100 returns to repeat steps 102 through 107. However, if it is determined at step 107 that it is done retrieving and adding to the database prior captured data, the prior data captured process 100 then exits at step 109.

Illustrated in FIG. 7 is the facility background data capture process 120 that can be utilized by the input data capture process 60 that is in efficiency analysis system 40 described in this disclosure. The facility background data capture process 120 allows the user to capture facility background data. The facility background data capture process is first initialized at step 121.

The facility background data capture process 120 then enables the user to add or modify facility address data at step 122. At step 123, the user is enabled to add or modify facility currency data. At steps 124 and 125, the facility background data capture process 120 enables the user to add or modify facility patient days data or facility case mix index data. At step 126, the user is enabled to add or modify facility patient volume data.

At step 131, the facility background data capture process 120 then determines whether this is the first save of the data for the selected facility. If it is not the first save of data for the selected facility, the facility background data capture process 120 then proceeds to step 139. However, if it is determined at step 131 that this is the first time to save data for the select facility, the facility background data capture process 120 then creates and adds the standard departments for the selected facility at step 132. The facility background data capture process 120 then exits at step 139.

Illustrated in FIG. 8A is the financial summary category process 140 that can be utilized by the input data capture process 60 that is in efficiency analysis system 40 described in this disclosure. The financial summary category process 140 enables a user to add or modify facility financial category data. The financial summary category process 140 is first initialized at step 141. At step 142, the user is prompted to select the facility financial class, such as assets, expenses, revenues, or liabilities, for data capture.

The standard facility financial categories for the selected financial class are then listed at step 143 so that the user consultant can add or modify nonstandard facility financial data categories at step 144. At step 145, the user is prompted to select the department for data capture. At step 146, the facility summary category process 140 then lists the standard department financial categories. At step 151, the user is prompted to add or modify non standard financial data categories for the selected department.

At step 152, the user is prompted to select the modality for data capture. At step 153, the financial summary category process 140 then lists the standard modality financial data categories so that the user may add or modify non-standard modality financial data categories for the selected modality at step 154.

The financial summary category process 140 then performs the financial summary capture process at step 156. The financial summary capture process is herein defined in further detail with regard to FIG. 8B. After performing the financial summary capture process, the financial summary category process 140 then exits at step 159.

Illustrated in FIG. 8B is the financial summary capture process 160 that can be utilized by financial summary category process 140. The financial summary capture process 160 allows the user to capture financial summary data for each of the categories previously defined. The financial summary capture process 160 is first initialized at step 161.

The user then selects the facility financial class for data capture at step 162. At step 163, the user specifies the date range for the data to be collected. Next, the standard and nonstandard facility financial categories are listed at step 164 so the user consultant may add or modify amounts for each of the facility financial categories for the specified date range at step 165. The amounts are then normalized to annualized amounts using the entered amount and the date range.

At step 166, the user is prompted to select the department for data capture. At 171, the standard and non-standard department financial categories are listed so that the user may add or modify amounts for each of the department financial categories at step 172. The amounts are normalized to annualized amounts using the entered amount and the date range. At step 173, the user is prompted to select the appropriate modality. At step 174, the standard and non-standard modality financial categories are listed so that the user may add or modify amounts for each of the modality financial categories at step 175. The amounts are then normalized to annualized amounts using the entered amount and the date range.

The financial summary capture process 160 then exits at step 179 and returns to the financial summary category process 140.

Illustrated in FIG. 9 is the task time capture process 180 that can be utilized by the input data capture process 60 that is in efficiency analysis system 40 described in this disclosure. The task time capture process 180 allows the user to capture task time and details for the selected facility, departments, modalities, and procedures. The user can also add or modify scheduled time and backlog time.

First, the task time capture process 180 is initialized at step 181. At step 182, the user is prompted to select the facility department, modality, procedure, process name, and data collection date for data capture. At step 183, the user is empowered to add or modify task time and details.

At step 184, the task time process 180 determines whether there is backlog task type data to be processed. If it is determined that there is no backlog task type data to be processed, the task time capture process 180 then proceeds to step 189. However, if it is determined at step 185 that there is backlog task type data to be processed, the task time capture process 180 then enables the user to add or modify the scheduled and backlog time at step 185. At step 186, the task time capture process 180 then calculates the backlog task step proxy times. The task time capture process 180 then exits at step 189.

Illustrated in FIG. 10 is the personnel data capture process 200 that can be utilized by the input data capture process 60 that is in efficiency analysis system 40 described in this disclosure. The personnel data capture process 200 allows the user to capture full time employment data for department and modality as well as benefit and salary data.

First the personnel data capture process 200 is initialized at step 201. At step 202 the user consultant is prompted to select a facility department and modality for data capture. Step 203 lists each job title for the selected department and modality. Step 204 enables the user to add or modify the number of full-time equivalent employees. The personnel data capture process 200 then enables the user to add or modify benefits and average salary data for the selected department and modality at steps 205 and 206. The personnel data capture process 200 then exits at step 209.

Illustrated in FIG. 11 is the supplier information process 220 that can be utilized by the input data capture process 60 that is in efficiency analysis system 40 described in this disclosure. The supplier information process 220 enables a user to input and modify top vendor and item data provided by each vendor.

First, the supplier information process is initialized at step 221. The user is prompted to select the appropriate facility department and modality for data capture at steps 222 and 223, respectively. At step 224, the user is enabled to add or modify the top vendor data and modify the top data items provided by the top data vendors at step 225. The supplier information process then exits at step 229.

Illustrated in FIG. 12 is the payor capture process 240 that can be utilized by the input data capture process 60 that is in efficiency analysis system 40 described in this disclosure. The payor capture process 240 enables the consultant or user to add or modify names of procedures and services and the percentage of total payor contribution for those procedures or services.

First, the payor capture process is initialized at step 241. At step 243, the user is prompted to select the appropriate facility department for data capture. The payor capture process 240 then enables the user to add or modify the name of the payor and the percentage of total payor contribution for each procedure or service at step 245. The payor capture process 240 then exits at step 249.

Illustrated in FIG. 13 is the flow chart of the procedure definition capture process 260 that can be utilized by the input data capture process 60 that is in efficiency analysis system 40 described in this disclosure. The procedure definition capture process 260 enables a user to add or modify procedures and create internal CPT codes for each additional procedure.

First, the procedure definition capture process 260 is initialized at step 261. At steps 262 and 263 the user is prompted to select the appropriate department and modality for data capture. The procedures and (internal or AMA) CPT codes for each procedure are then listed at step 264. The listing of the procedures and CPT codes for each procedure enables the user to add or modify comment data for each procedure at step 265 and add or modify new procedure codes and comments at step 266. The procedure definition capture process 260 then exits at step 269.

Illustrated in FIG. 14 is the imaging unit data capture process 280 that can be utilized by the input data capture process 60 that is in efficiency analysis system 40 described in this disclosure. The imaging unit data capture process 280 enables a user to add or modify data for the unit by modality, department and facility.

The imaging unit data capture process 280 is first initialized at step 281. The user is prompted to select the appropriate department and modality for data capture at steps 282 and 283, respectfully. At step 284, the image unit data capture process 280 determines whether the user wishes to enter a new unit. If it is determined at step 284 that user does not wish to enter a new unit, the imaging unit data capture process 280 then proceeds to step 286. If it is determined at step 284 that the user wishes to enter a new unit, the new unit name is then entered at step 285.

At step 286, the imaging unit data capture process 280 then selects the appropriate unit for data capture from the list of unit names. With the unit selected for data capture, the user is now enabled to add or modify unit information data, such as location, hours of operation, manufacturer, model and special features of the specific medical imaging unit class at step 287. The imaging unit data capture process 280 then exits at step 289.

Illustrated in FIG. 15 is a flow chart of an example of the volume and benchmark time data capture process 300 that can be utilized by the input data capture process 60 that is in efficiency analysis system 40 described in this disclosure. The volume and benchmark time data capture process 300 enables a user to identify or modify the standard time allowable for each procedure and the patient volume for each procedure and the patient volume for each procedure by modality, department and facility.

The volume and benchmark time data capture process 300 is first initialized at step 301. At steps 302 and 303, the user is prompted to select the appropriate department and modality for data capture. The imaging unit for data capture is then selected at step 304. With the appropriate imaging unit selected for data capture, the volume and benchmark time data capture process 300 then lists the procedure codes for the selected modality at step 305. Next, in step 306, the user consultant enters the date range for the collected procedure volume data that will be entered as described in Step 312. This listing of procedure codes enables the user consultant to add or modify standard time to perform the procedure on the selected imaging unit for each listed procedure in step 311. Step 312 allows the user consultant to add or modify the patient volume performed on the selected imaging unit for each listed procedure. The procedure volume for each procedure is normalized to an annualized volume using the date range and the entered patient volume. The volume and benchmark time data capture process 300 then exits at step 319.

Illustrated in FIG. 16 is the collect physician procedure preferences process 320 that can be utilized by the input data capture process 60 that is in efficiency analysis system 40 described in this disclosure. The collect physician procedure preferences process 320 enables a user to add or modify the physician preferred material to perform each procedure for each facility, department and modality.

The collect physician procedure preferences process 320 is first initialized at step 321. At steps 322 and 323, the user is prompted to select the appropriate department and modality for data capture. Once the appropriate department and modality are selected, the collect physicians procedure preferences process 320 then lists the procedures for the selected modality at step 324. Next in step 325, the user consultant selects one of the procedures. In Step 326, the user consultant selects one of the physicians for the procedure.

The collect physician procedure preferences process 320 then allows the user to add or modify the list of materials and quantity of each material item preferred by the selected physician when performing the selected procedure at step 327. The collect physician procedure preferences process 320 then exits at step 329.

Illustrated in FIG. 17 is a flow chart of an example of the process captured data process 340 that can be utilized by the efficiency analysis system 40 described in this disclosure. The process captured data process 340 computes a variety of values to assist a user in identifying potential areas of productivity improvement.

First, the process capture data process is initialized at step 341. At step 342, the process capture data process 340 then computes the expense profiles from the captured data. The procedure cycle time from the captured data is then processed at step 343.

At step 344, the process captured data process 340 then compares the supply expense/inventory value for the selected facility against the benchmark data. At step 345, the potential inventory and labor savings is computed from the captured data for the selected facility. At step 346, the process captured data process 340 then computes the procedure volume for the selected facility. At step 351 and 352, the process capture data process 340 then computes the procedure volume per full time employment and the cost per each procedure for the selected facility. At step 353, the process capture data process 340 then computes the indicator scorecard and answers. The process capture data process 340 then exits at step 359.

Illustrated in FIG. 18 is a flow chart of an example of the demographics report process 360 that can be utilized by the report data process 80 that is in efficiency analysis system 40 described in this disclosure. The demographics report process 360 provides demographic data for selected facilities by enterprise, region/market, or individual facility.

First, the demographics report process 360 is initialized at step 361. At step 363, the demographics report process 360 then acquires facility demographic data for each of the selected facilities. This facility demographic data includes, but is not limited to, the facility name, address, city, county, state, phone, fax, case mix index, residency and transplant indicator which indicates whether the hospital has a transplant program. At step 365, the demographics report for the selected facility or facilities is then created. The demographics report is then sent to the device selected at step 82, (FIG. 5) at step 367. The demographics report process 360 then exits at step 369.

Illustrated in FIG. 19 is a flow chart of an example of the financial report process 380 that can be utilized by the report data process 80 that is in efficiency analysis system 40 described in this disclosure. The financial report process 380 enables a user to receive facility financial data by enterprise, region/market or individual facility.

First, the financial report process 380 is initialized at step 381. At step 383, the financial report process 380 then acquires financial data for each selected facility. This facility financial data includes, but is not limited to, the facility name, address, city, county, state, income, assets, revenues, liabilities for specified fiscal year, salaries, expenses, savings opportunities, calculate total number of procedures, amount of non-labor expenses and calculate the non-labor cost/procedure.

At step 385, the financial report for the selected facility or facilities is then created. The financial report is then sent to the device selected at step 82, (FIG. 5) at step 387. The financial report process 380 then exits at step 389.

Illustrated in FIG. 20 is a flow chart of an example of the expense and inventory report process 400 that can be utilized by the report data process 80 that is in efficiency analysis system 40 described in this disclosure. The expense and inventory report process 400 enables a user to prepare reports regarding facility expense and inventory data for facilities within an enterprise, region or market, or an individual facility.

First, the expense and inventory report process 400 is initialized at step 401. At step 402, the expense and inventory report process 400 then acquires expense and inventory data for the selected facilities. This facility expense and inventory data includes, but is not limited to, the facility name, address, city, county, state, and actual expenses for specific departments and benchmarks. At step 403, the expense and inventory report process 400 then calculates the lower, midpoint, and upper benchmarks to be used for comparisons.

At step 404, the expense and inventory report for the selected facility or facilities is then created. The expense and inventory report is then sent to the device selected at step 82, (FIG. 5) at step 405. The expense and inventory report process 400 then exits at step 409.

Illustrated in FIG. 21 is a flow chart of an example of the cycle time report process 420 that can be utilized by the report data process 80 that is in efficiency analysis system 40 described in this disclosure. The cycle time report process 420 enables a user to obtain the average delta time between consecutive task for selected facilities, departments, modalities and procedures. In this way, the user can determine the effectiveness of a particular department and modality for specific procedures.

First, the cycle time report process 420 is initialized at step 421. The cycle time report process 420 then prompts the user to select the appropriate department modality and procedure to report at step 422.

At step 422, the cycle time report process 420 then acquires the average delta time between consecutive tasks for each selected facility and the average time between the first and last task time points for each selected facility.

At step 423, the cycle time report for the selected facility or facilities is then created. The cycle time report is then sent to the device selected at step 82, (FIG. 5) at step 424. The cycle time report process 420 then exits at step 429.

Illustrated in FIG. 22 is a flow chart of an example of the bed utilization report process 440 that can be utilized by the report data process 80 that is in efficiency analysis system 40 described in this disclosure. The bed utilization report process 440 provides the user consultant with the ability to obtain bed utilization data by facilities in an enterprise or particular region and market or by an individual facility.

First, the bed utilization report process 440 is initialized at step 441. At step 443, the bed utilization report process 440 then acquires facility bed utilization data, including, but not limited to facility name, city, state, bed utilization type, number of available beds, staffed beds, licensed beds, admissions, patient days, discharges, and average length of stay by bed utilization type.

At step 445, the bed utilization report for the selected facility or facilities is then created. At step 447, the bed utilization report is then sent to the device selected at step 82, (FIG. 5). The cycle time report process 440 then exits at step 449.

Illustrated in FIG. 23 is a flow chart of an example of the productivity report process 460 that can be utilized by the report data process 80 that is in efficiency analysis system 40 described in this disclosure. The productivity report process 460 enables a user to obtain output data with regard to procedure volume and the personnel requirements for selected facilities. Then, the productivity report process 460 computes the actual productivity effectiveness by calculating the number of procedures for each full time employee.

First, the productivity report process 460 is initialized at step 461. At step 462, the productivity report process 460 then acquires facility productivity data, including facility name, and full time equivalents by modality and departments. At step 463, the productivity report process 460 acquires the procedure volume and number of full-time equivalents (FTE) for each of the selected facilities for each job type. Then, the productivity report process 460 calculates the number of procedures for each full-time equivalent employee. At step 464, the productivity report process 460 calculates for each procedure the relative work value unit from the relative work value unit benchmarks. The number of relative work value units for the procedure volume for each procedure is then calculated. Lastly, the productivity report process 460 then calculates the total number of relative work value units for each full time equivalent for each of the selected facility.

At step 465, the productivity report process 460 then acquires the procedure volume benchmark for each job classification for comparison with the calculated procedure volume for each full-time equivalent employee in the selected department and modality. At step 466, the productivity report for the selected facility or facilities is then created. The productivity report is then sent to the device selected at step 82, (FIG. 5) at step 467. The productivity report process 460 then exits at step 469.

Illustrated in FIG. 24 is a flow chart of an example of the saving and indicator score report process 480 that can be utilized by the report data process 80 that is in the efficiency analysis system 40 described in this disclosure. The savings and indicator score report process 480 enables a user to acquire facility savings and indicator data for selected facilities. The indicator data identifies those areas in which savings could be obtained for a particular facility and opportunities to implement cost saving methodologies.

First, the saving and indicator report process 480 is initialized at step 481. At step 482, the saving and indicator report process 480 acquires the facility saving and indicator score report data, including facility name. Then, the saving and indicator report process 480 acquires defects from indicator answers for each selected facility. The saving and indicator report process 480 also acquires the number of opportunities for each selected facility. At step 483, the saving and indicator score report process 480 then calculates the indicator score for each defect and opportunities for each of these selected facilities.

At step 484, the create saving and indicator score report for the selected facility or facilities is then created. The saving and indicator score report is then sent to the device selected at step 82, (FIG. 5) at step 485. The saving and indicator report process 480 then exits at step 489.

Illustrated in FIG. 25 is a flow chart of an example of the ad-hoc report process 500 that can be utilized by the report data process 80 that is in efficiency analysis system 40 described in this disclosure. The ad-hoc report process 500 enables a user to obtain any selected type key data to be retrieved and computed and output in a user defined report.

First, the ad-hoc report process 500 is initialized at step 501. At step 502, the user is prompted to select the criteria to choose facilities with specific values or ranges of data fields for the ad-hoc report to be generated. At step 503, the ad-hoc report process 500 then selects key data fields to retrieve. At step 504, the ad-hoc report process 500 specifies any totals and sort criteria and creates a chart from the results. These selected type key data fields, sort criteria, and output totals are defined by the user.

After the facility or facilities for the report is selected at step 505, the ad-hoc report process 500 then prompts the user to select the terminal or printer for display at step 505.

At step 506, the create ad-hoc report for the selected facility is created. The ad-hoc report is then sent to the selected device at step 507. At step 508, the ad-hoc report process 500 then determines whether it is done creating reports for the selected facilities. If it is determined at step 508 that the ad-hoc report process 500 is not done, the ad-hoc report process 500 then returns to repeat steps 502 through 508. However, if it is determined at step 508 that there are no more reports to be generated, the ad-hoc report process 500 then exits at step 509.

The efficiency and cost analysis system and method 40 comprises an ordered listing of executable instructions for implementing logical functions. The ordered listing can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate, or transport the program for use by or in connection with the instruction execution system, apparatus, or device.

The computer readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

The foregoing description has been presented for purposes of illustration and description. It is not intended to be exhaustive or to limit the invention to the precise forms disclosed. Obvious modifications or variations are possible in light of the above teachings. The flow charts of this disclosure show the architecture, functionality, and operation of a possible implementation of the register usage optimization compilation and translation system. In this regard, each block represents a module, segment, or portion of code, which comprises one or more executable instructions for implementing the specified logical function(s). It should also be noted that in some alternative implementations, the functions noted in the blocks may occur out of the order noted in the figures, or for example, may in fact be executed substantially concurrently or in the reverse order, depending upon the functionality involved.

The system and methods discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method for providing efficiency and cost analysis for a business organization comprising the steps of:
storing a plurality of operational data obtained from a plurality of business organizations;
processing the plurality of operational data to identify productivity improvements in the business organization; and
calculating an operational efficiency of the business organization using said operational data.

2. The method of claim 1, further comprising the step of:
generating at least one report that identifies productivity improvements to increase said operational efficiency in the business organization.

3. The method of claim 2, wherein said step of generating at least one report further comprises the step of:
generating a productivity improvement report selected from the group consisting of financial, labor, productivity, demographics, expense, inventory, cycle time, resource utilization, savings and material reports.

4. The method of claim 1, wherein the productivity improvements are identified by a factor selected from the group consisting of at the industry level, facility level and department level.

5. The method of claim 1, further comprising the step of:
performing an ad-hoc query on said plurality of operational data.

6. The method of claim 5, wherein said step of performing ad-hoc query further comprises:
generating an ad-hoc report.

7. A system for providing efficiency and cost analysis for a business organization comprising:
means for storing a plurality of operational data obtained from a plurality of business organizations;
means for processing the plurality of operational data to identify productivity improvements in the business organization; and
means for calculating an operational efficiency of said business organization using said operational data.

8. The system of claim 7, further comprising:
means for generating at least one report that identifies productivity improvements to increase said operational efficiency in the business organization.

9. The system of claim 8, wherein said report generating means further comprises:
means for generating a productivity improvement report selected from the group consisting of financial, labor, productivity, demographics, expense, inventory, cycle time, resource utilization, savings and material reports.

10. The system of claim 7, wherein the productivity improvements are identified by a factor selected from the group consisting of at the industry level, facility level and department level.

11. The system of claim 7, further comprising:
means for performing an ad-hoc query on said plurality of operational data.

12. The system of claim 11, wherein said performing an ad-hoc query means further comprises:
means for generating an ad-hoc report.

13. A system for providing efficiency and cost analysis for a business organization comprising:
business operations database containing a plurality of operational data obtained from a plurality of business organizations;
processor logic that analyzes the plurality of operational data to identify productivity improvements in the business organization; and
analysis logic that calculates a operational efficiency of said business organization using said operational data.

14. The system of claim 13, further comprising:
reporting logic that generates at least one report that identifies productivity improvements in the business organization.

15. The system of claim 14, wherein the productivity improvements are identified by a factor selected from the group consisting of at the industry level, facility level and department level.

16. The system of claim 13, further comprising:
an ad-hoc query generator that generates an ad-hoc query for said plurality of operational data.

17. The system of claim 16, wherein said ad-hoc query generator further comprises:
an ad-hoc report generator that generates an ad-hoc report.

18. A computer readable recording medium having a program providing efficiency and cost analysis for a business organization, said program comprising:
means for storing a plurality of operational data obtained from a plurality of business organizations;
means for processing the plurality of operational data to identify productivity improvements in the business organization; and
means for calculating an operational efficiency of said business organization using said operational data.

19. The computer readable medium of claim 18, further comprising:
a first routine means for generating at least one report that identifies productivity improvements to increase said operational efficiency in the business organization.

20. The computer readable medium of claim 19, wherein the productivity improvements are identified by a factor selected from the group consisting of industry level, facility level and department level.

21. The computer readable medium of claim 18, further comprising:
a second routine means for generating a productivity improvement report selected from the group consisting of financial, labor, productivity, demographics, expense, inventory, cycle time, resource utilization, savings and material reports.

22. The computer readable medium of claim 21, further comprising:
a third routine means for performing an ad-hoc query on said plurality of operational data.

23. The computer readable medium of claim 22, further comprising:
a fourth routine means for generating an ad-hoc report.
